(19) United States
(12) Patent Application Publication
(10) Pub. No.: US 2018/0281760 A1
(43) Pub. Date: Oct. 4, 2018

(54) CONTROL DEVICE FOR FOUR-WHEEL DRIVE VEHICLE

(71) Applicant: TOYOTA JIDOSHA KABUSHIKI KAISHA, Toyota-shi (JP)

(72) Inventor: Ryochi WATANABE, Susono-shi (JP)

(73) Assignee: TOYOTA JIDOSHA KABUSHIKI KAISHA, Toyota-shi (JP)

(21) Appl. No.: 15/926,281

(22) Filed: Mar. 20, 2018

(30) Foreign Application Priority Data
Mar. 30, 2017 (JP) 2017-066768

(51) Int. Cl. B60T 8/1769; B60T 8/1766; B60T 8/32; B60K 17/346; B60K 17/348

(52) U.S. Cl. CPC B60T 8/1769; B60T 8/1766; B60K 17/348; B60K 17/3462; B60T 8/322

(57) ABSTRACT

The control device for a four-wheel drive vehicle includes a differential restriction control unit configured to cause the differential restriction device, which is enable a differential restriction degree between a front wheel rotary shaft and a rear wheel rotary shaft, to change the differential restriction degree and a braking control unit configured to cause the braking device to perform EBD control and ABS control. The braking control unit is configured to cause the braking device to suspend the EBD control when the ABS control is started while the EBD control is being performed, and the differential restriction control unit is configured to change the differential restriction degree to a third degree larger than a first degree and equal to or smaller than a second degree when the ABS control is started while the EBD control is being performed.

### BACKGROUND OF THE INVENTION

### 1. Field of the Invention

The present invention relates to a control device for a four-wheel drive vehicle including: a differential restriction device configured to restrict a differential between a front wheel rotary shaft and a rear wheel rotary shaft; and a brake control device configured to adjust a ratio (braking force distribution ratio) between a braking force of front wheels and a braking force of rear wheels.

### 2. Description of the Related Art

In general, most control devices for vehicles capable of anti-skid (ABS) control are mounted with electronic brake force distribution (EBD) for controlling distribution of braking forces of front wheels and rear wheels and distribution of braking forces of left wheels and right wheels. According to the control using the EBD (hereinafter also referred to as “EBD control”), for example, the braking force of the front wheels is increased when a wheel speed of the front wheels becomes higher than a wheel speed of the rear wheels, and is reduced when the wheel speed of the front wheels becomes lower than the wheel speed of the rear wheels. As a result, the braking force of the front wheels and the braking force of the rear wheels are controlled along such a distribution ratio (that is, ideal distribution ratio based on a vertical load ratio between the front wheels and the rear wheels) as to substantially stabilize a slip ratio of the front wheels and a slip ratio of the rear wheels (for example, refer to Japanese Patent Application Laid-open (Kokai) No. H10-138895).

Incidentally, the above-mentioned ideal distribution ratio has a characteristic that a ratio of the braking force of the rear wheels to the braking force of the front wheels becomes lower as the braking force becomes larger. In contrast, in a four-wheel drive vehicle, a distribution ratio between the braking force of the front wheels and the braking force of the rear wheels (hereinafter also referred to as “front-rear braking force distribution ratio”) when braking is performed under such a state as to fully allow a differential between the front wheels and the rear wheels (state under which limitation on the differential has been released), is normally set to a constant level.

In short, the front-rear braking force distribution ratio has a proportional relationship. That is, in a graph with a horizontal axis representing the braking force of the front wheels and a vertical axis representing the braking force of the rear wheels, a line indicating the ideal distribution ratio is shown as a curve passing through the origin with a slope decreasing as the braking force of the front wheels increases, while a line indicating the front-rear braking force distribution ratio is shown as a straight line passing through the origin and increasing with a constant slope. Therefore, the front-rear braking force distribution ratio and the ideal distribution ratio agree with each other at a specific point on the graph.

When the braking forces of the front wheels and the rear wheels increase along the front-rear braking force distribution ratio in accordance with a braking request value requested by a driver of a vehicle, the slip ratio of the rear wheels is lower than the slip ratio of the front wheels in a range from a point (origin of the graph) immediately after the braking forces of the front wheels and the rear wheels has occurred to the point of the agreement with the braking forces of the front wheels and the rear wheels based on the ideal distribution ratio. Meanwhile, the slip ratio of the rear wheels becomes higher than the slip ratio of the front wheels when the braking forces of the front wheels and the rear wheels become larger than the point of the agreement. Therefore, for example, when the slip ratio of the rear wheels exceeds the slip ratio of the front wheels, the EBD control may be executed to maintain the braking force of the rear wheels at a constant level, to thereby be able to prevent the braking force of the rear wheels from becoming excessive.

Incidentally, a vehicle normally includes a loading bed or a luggage compartment on a rear wheel side, and hence a difference between a rear wheel load at a time of maximum loading and a rear wheel load at a time of minimum loading (for example, with only the driver on board) is large. Such a tendency is particularly noticeable in a cargo vehicle represented by a truck. For example, in a graph shown in FIG. 5 with a horizontal axis representing a braking force Fbf of the front wheels and a vertical axis representing a braking force Fbr of the rear wheels, vertical load distribution between the front wheels and the rear wheels (hereinafter referred to as “front-rear vertical load distribution”) at the time of maximum loading of the cargo vehicle is indicated by a one-dot chain line C1, while front-rear vertical load distribution at the time of the minimum loading is indicated by a one-dot chain line C2.

The front-rear braking force distribution ratio is normally set with the front-rear vertical load distribution at the time of maximum loading being used as a reference. More specifically, as indicated by a straight line L1, the front-rear braking force distribution ratio for the vehicle is set as a straight line close to the front-rear vertical load distribution at the time of maximum loading, in which the braking force of the rear wheels is smaller than a braking force of the rear wheels determined based on the front-rear vertical load distribution at the time of maximum loading.

When the front-rear braking force distribution ratio is thus set with a front-rear vertical load distribution ratio at the time of maximum loading being used as a reference, the straight line L1 indicating the set front-rear braking force distribution ratio and the one-dot chain line C2 indicating the front-rear vertical load distribution at the time of minimum loading intersect in a region exhibiting relatively small braking forces of the front wheels and the rear wheels. Therefore, when a loading amount is small, the EBD control is executed starting from the region exhibiting relatively small braking forces of the front wheels and the rear wheels so as to prevent the braking force of the rear wheels from becoming excessive.

However, depending on road conditions under which the vehicle is traveling, the ABS control may be executed on the front wheels or the rear wheels during the execution of the EBD control in some cases. In such cases, it is required to individually perform braking control on each of the front, rear, left, and right wheels, and hence the execution of the EBD control for maintaining the braking force of the rear wheels is suspended. When the execution of the EBD control is suspended, the control of the braking force of the rear wheels is changed to the control to be performed in accordance with the set front-rear braking force distribution ratio. In this case, as shown in FIG. 5, assuming that the ABS control is executed at a point R, the braking force of the rear wheels increases from the point R along a solid line L3 to exceed the one-dot chain line C2 indicating the front-rear vertical load distribution at the time of minimum loading. Therefore, the braking force of the rear wheels becomes excessive, which raises a fear that it may be difficult to secure travelling stability of the vehicle.

### SUMMARY OF THE INVENTION

The present invention has been made in order to solve the above-mentioned problem. That is, one of the objects of the present invention is to provide a control device for a four-wheel drive vehicle for which a front-rear braking force distribution ratio for a hydraulic brake of the vehicle (when restriction on the differential operation is released) is set with front-rear vertical load distribution at a time of maximum loading being used as a reference, the control device being capable of preventing a lateral force of rear wheels from decreasing even when ABS control is executed while EBD control is being executed, to thereby be able to secure travelling stability of the vehicle.

A control device (hereinafter also referred to as “present invention device”) for a four-wheel drive vehicle according to the present invention is applied to a four-wheel drive vehicle. The vehicle (10) includes: a driving unit (20), a center differential device (31), a differential restriction device (34), and a braking device (40).

The driving unit is configured to generate a driving force.

The center differential device is configured to: transmit the driving force to a front wheel rotary shaft (32) and a rear wheel rotary shaft (33); and allow a differential between the front wheel rotary shaft and the rear wheel rotary shaft.

The differential restriction device is configured to enable a restriction degree (Tcu) of the differential between the front wheel rotary shaft and the rear wheel rotary shaft to be changed to have a value equal to or larger than a first degree (Tcu=0), which fully allows the differential, and equal to or smaller than a second degree (Tcu=Tcumax), which disallows the differential, and is larger than the first degree.

The braking device is configured to: apply hydraulic pressure, which increases as a braking request value (Pm) being a request value of a braking force to be applied to the vehicle increases, to hydraulic friction braking devices (70) provided for respective wheels, which include front left and right wheels and rear left and right wheels, through a hydraulic pressure passage (50, 60, and 80) shared by the respective wheels, to thereby change a braking force (Fbf) of the front left and right wheels and a braking force (Fbr) of the rear left and right wheels so that a distribution ratio between the braking force of the front left and right wheels and the braking force of the rear left and right wheels maintains a constant value; and enable braking forces of the respective wheels to be set independently of one another by changing the hydraulic pressure applied to the hydraulic friction braking devices for the respective wheels independently wheel by wheel.

Further, the present invention device comprises a differential restriction control unit (110) and a braking control unit (120).

The differential restriction control unit is configured to cause the differential restriction device to change a differential restriction degree.

The braking control unit is configured to: determine, when the differential restriction degree is set to the first degree, whether a first specific state that enables the braking force of the rear left and right wheels to be estimated to have exceeded a rear wheel braking force threshold (Fbrth) has occurred (Step 930), and cause, when determining that the first specific state has occurred (Step 930: Yes), the braking device to perform distribution ratio adjustment braking for increasing the braking force of the front left and right wheels by increasing the hydraulic pressure applied to the hydraulic friction braking devices for the front left and right wheels as the braking request value increases, and maintaining the braking force of the rear left and right wheels at a constant value by maintaining the hydraulic pressure applied to the hydraulic friction braking devices for the rear left and right wheels (Step 940); and calculate, when the differential restriction degree is set to the first degree, a slip ratio (SL) of each of the front left and right wheels and the rear left and right wheels, and cause the braking device to perform anti-skid braking (Step 820 to Step 860) for decreasing a braking force of a specific wheel having the calculated slip ratio exceeding a slip ratio threshold (SLth) by decreasing the hydraulic pressure applied to one of the hydraulic friction braking devices for the specific wheel, to thereby decrease a slip ratio of the specific wheel.

In the above-mentioned configuration, when the differential restriction degree is set to the first degree, the differential operation (relative rotation) between the front wheel rotary shaft and the rear wheel rotary shaft is fully allowed. In other words, for example, when the differential restriction degree is set to the first degree, the differential restriction between the front wheel rotary shaft and the rear wheel rotary shaft is completely released. Further, in other words, when the differential restriction degree is set to the first degree, a coupling torque of the center differential device is “0”. When the differential restriction degree is set to the second degree, the differential operation (relative rotation) between the front wheel rotary shaft and the rear wheel rotary shaft are not allowed. In other words, for example, when the differential restriction degree is set to the second degree, the differential restriction between the front wheel rotary shaft and the rear wheel rotary shaft is maximized. Further, in other words, when the differential restriction degree is set to the second degree, a coupling torque of the center differential device is a maximum torque. The first specific state represents, for example, a state under which a slip ratio of the rear left and right wheels is higher than a slip ratio of the front left and right wheels. For example, when a condition that an average value between the slip ratios of the rear left and right wheels has become higher than an average value of the slip ratios of the front left and right wheels is satisfied, it is possible to determine that the first specific state has occurred.

The above-mentioned distribution ratio between the braking force of the front left and right wheels and the braking force of the rear left and right wheels, that is, a braking force distribution ratio, is set with an ideal distribution ratio based on a vertical load ratio at the time of maximum loading being used as a reference so that, for example, a vehicle with greatly different a maximum loading amount and a minimum loading amount can exert a sufficient braking force at the time of maximum loading. Consequently, for example, when the differential restriction degree is set to the first degree at a time of minimum loading, the first specific state that enables the braking force of the rear left and right wheels to be estimated to have exceeded the rear wheel braking force threshold may occur in some cases. When determining that the first specific state has occurred, the control device causes the braking device to execute the distribution ratio adjustment braking (namely, EBD control) for maintaining the braking force of the rear left and right wheels at a constant value. As a result, the braking force of the rear left and right wheels is set smaller than the braking force of the rear wheels based on the ideal distribution ratio at the time of minimum loading, which improves the travelling stability of the vehicle.

The braking control unit is configured to cause the braking device to suspend the distribution ratio adjustment braking (Step 960) when the anti-skid braking is started during a period in which the distribution ratio adjustment braking is being performed (Step 950: Yes), and the differential restriction control unit is configured to change the differential restriction degree to a third degree (Step 1090 and Step 1092), which is larger than the first degree and equal to or smaller than the second degree, when the anti-skid braking is started during the period in which the distribution ratio adjustment braking is being performed.

When the differential restriction degree is set to the third degree, the differential restriction degree becomes larger than the first degree. In other words, when the differential restriction degree is set to the third degree, the differential operation (relative rotation) between the front wheel rotary shaft and the rear wheel rotary shaft is partly or fully restricted. The third degree can be set to, for example, a state under which the coupling torque exerted by the center differential device is maximum, but there is a fear that the braking force of the rear wheels may increase sharply when the state is immediately changed from the first degree to the third degree. In view of the foregoing, the present invention device can prevent the braking force of the rear wheels from increasing sharply by, for example, increasing the coupling torque toward the state under which the coupling torque becomes maximum at a predetermined rate.

Therefore, according to the above-mentioned configuration, even when anti-skid braking (ABS control) is executed while the EBD control is being executed during the braking in the four-wheel drive vehicle for which the front-rear braking force distribution for a case in which the restriction on the differential operation has been released is set with the front-rear vertical load distribution at the time of maximum loading being used as a reference, it is possible to prevent the lateral force of the rear wheels from decreasing, and to secure the travelling stability of the vehicle.

In one of the embodiments of the control device for a four-wheel drive vehicle according to the present invention, the differential restriction control unit may be configured to: determine, when the differential restriction degree is set to the second degree (Step 1080), whether there has occurred a second specific state under which the first specific state is highly likely to occur assuming that the differential restriction degree is set to the first degree and the braking force of the front left and right wheels and the braking force of the rear left and right wheels are increased during a period in which a distribution ratio between the braking force of the front left and right wheels and the braking force of the rear left and right wheels is maintained at a constant level (Step 1070); and change, when determining that the second specific state has occurred (Step 1070: No), the differential restriction degree from the second degree to the first degree (Step 1075).

The second specific state represents a state under which a situation that requires such a braking force that the slip ratio of the rear wheels is higher than the slip ratio of the front wheels is expected to occur assuming that the vehicle is traveling with the differential restriction having been released. For example, in regard to the vehicle body speed at a start of braking, as the vehicle body speed becomes higher, a larger braking force is required for reducing the vehicle body speed. Therefore, it is possible to determine that the second specific state has occurred when, for example, a condition that the vehicle body speed at the start of braking is equal to or higher than a predetermined vehicle body speed threshold is satisfied.

According to the above-mentioned configuration, the present invention device changes the differential restriction degree to the first degree when determining that the second specific state has occurred with the differential restriction degree being set to the second degree, to thereby be able to generate the state under which the braking force of the rear wheels becomes larger than the rear wheel braking force threshold, namely, the first specific state. With this configuration, the distribution ratio adjustment braking (EBD control) is executed to prevent the braking force of the rear wheels from increasing, and to prevent the lateral force of the rear wheels from decreasing, which can secure the travelling stability of the vehicle.

In one of the embodiments of the control device for a four-wheel drive vehicle according to the present invention, the differential restriction control unit may be configured to set the differential restriction degree to the first degree (Step 1110) when the anti-skid braking is started (Step 950: Yes) before the braking force of the rear left and right wheels exceeds the rear wheel braking force threshold (Step 1105: Yes) during a period in which the differential restriction degree is set to the second degree (Step 1080) and the braking control unit is increasing the braking force of the front left and right wheels and the braking force of the rear left and right wheels.

As described above, for example, in the vehicle for which the front-rear braking force distribution ratio is set with the ideal distribution ratio at the time of maximum loading being used as a reference, the braking force of the rear wheels exerted when the differential restriction degree is set to the first degree is smaller than the braking force of the rear wheels determined based on the ideal distribution ratio at the time of minimum loading in a range below the rear wheel braking force threshold. Therefore, the differential restriction degree is set to the first degree in a range in which the braking force of the rear wheels is smaller than the rear wheel braking force threshold, to thereby be able to secure the travelling stability.

In the description given above, in order to facilitate understanding of the present invention, terms and/or reference symbols used in embodiments of the present invention described below are enclosed in parentheses, and are assigned to the elements of the present invention corresponding to the embodiments. However, the respective elements of the present invention are not limited to the embodiments defined by the terms and/or the reference symbols. Other objects, other features, and accompanying advantages of the present invention are readily understood from the description of the embodiments of the present invention to be given with reference to the following drawings.

### BRIEF DESCRIPTION OF THE DRAWINGS

FIG. 1 is a schematic diagram for illustrating a control device for a four-wheel drive vehicle according to a first embodiment of the present invention.

FIG. 2 is a schematic diagram for illustrating a braking device illustrated in FIG. 1.

FIG. 3 is a diagram for explaining a relationship between a braking slip ratio and a braking force, which is provided to the braking device illustrated in FIG. 1.

FIG. 4 is a diagram for explaining a distribution ratio between a braking force of front wheels and a braking force of rear wheels in the control device illustrated in FIG. 1.

FIG. 5 is a diagram for explaining a distribution ratio between the braking force of the front wheels and the braking force of the rear wheels in a related-art control device.

FIG. 6 is a timing chart regarding hydraulic pressure on the front wheels and hydraulic pressure on the rear wheels, for explaining an operation performed by the related-art control device.

FIG. 7 is a timing chart regarding the hydraulic pressure on the front wheels, the hydraulic pressure on the rear wheels, a wheel speed of the front wheels, a wheel speed of the rear wheels, and a coupling torque, for explaining an operation performed by the control device illustrated in FIG. 1.

FIG. 8 is a flowchart for illustrating an “ABS execution flag setting routine” executed by a CPU of a braking ECU of the control device illustrated in FIG. 1.

FIG. 9 is a flowchart for illustrating an “EBD execution flag setting routine” executed by the CPU of the braking ECU of the control device illustrated in FIG. 1.

FIG. 10 is a flowchart for illustrating a “coupling torque control routine” executed by a CPU of a 4WD ECU of the control device illustrated in FIG. 1.

FIG. 11 is a flowchart for illustrating a “coupling torque control routine” executed by a CPU of a 4WD ECU of a control device for a four-wheel drive vehicle according to a second embodiment of the present invention.

### DESCRIPTION OF THE EMBODIMENTS

### First Embodiment

### Configuration

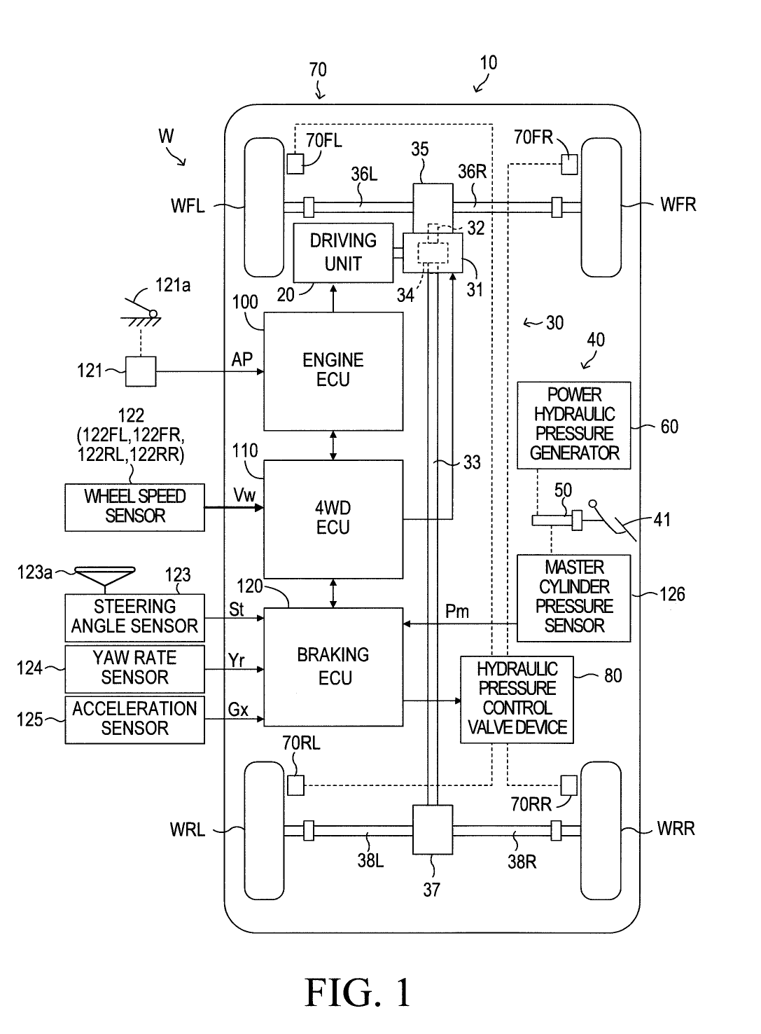

A control device (hereinafter referred to as “first control device”) for a four-wheel drive vehicle according to a first embodiment of the present invention is applied to a four-wheel drive vehicle (hereinafter simply referred to as “vehicle”) 10, as illustrated in FIG. 1.

The vehicle 10 comprises a driving unit 20 which generates a driving force for the vehicle, a driving force transmission mechanism 30, a braking device 40, an engine ECU 100, a 4WD ECU 110, a braking ECU 120, and the like. It should be noted that two or more of those ECUs may be integrated into one ECU.

The ECU is an abbreviated word for an electronic control unit, and is an electronic control circuit including, as a main component, a microcomputer including a CPU, a ROM, a RAM, a backup RAM (or a nonvolatile memory), an interface, and the like. The CPU is configured to execute instructions (routines) stored in the memory (ROM) to implement various functions described later.

Specifically, the driving unit 20 generates a driving force for driving wheels (the front left wheel WFL, the front right wheel WFR, the rear left wheel WRL, and the rear right wheel WRR) of the vehicle 10 via the driving force transmission mechanism 30. The driving unit 20 may be any type of a driving unit for a vehicle known in the art, such as a combination of an internal combustion engine and a transmission of a conventional vehicle, a combination of an electric motor and a transmission, a hybrid system which is a combination of an internal combustion engine, an electric motor and a transmission, or the like.

The driving force transmission mechanism 30 includes a center differential device 31, a front wheel rotary shaft 32, a rear wheel rotary shaft 33, a differential restriction/limiting device 34, a front wheel differential gear 35, a front left wheel axle 36L, a front right wheel axle 36R, a rear wheel differential gear 37, a rear left wheel axle 38L, a rear right wheel axle 38R, and the like.

The center differential device 31 is configured to transmit the driving force from the driving unit 20 to the front wheel rotary shaft 32 and the rear wheel rotary shaft (a propeller shaft) 33, and to allow a difference (differential) between a rotation speed of the front wheel rotary shaft 32 and a rotation speed of the rear wheel rotary shaft 33 (or to allow a differential operation between the front wheel rotary shaft 32 and the rear wheel rotary shaft 33, or to allow the front wheel rotary shaft 32 and the rear wheel rotary shaft 33 to rotate freely with each other). In the present embodiment, the center differential device 31 includes an electrically controlled differential restriction device 34.

The differential restriction device 34 varies a mutual restraining force between the front wheel rotary shaft 32 and the rear wheel rotary shaft 33 using the center differential device 31. Thus, the differential restriction device 34 has a function to control a differential restriction degree between the front wheel rotary shaft 32 and the rear wheel rotary shaft 33. The mutual restraining force between the front wheel rotary shaft 32 and the rear wheel rotary shaft 33 (that is, a coupling torque Tcu of the center differential device 31) is controlled by the 4WD ECU 110 as will be described in detail later.

The driving force of the front wheel rotary shaft 32 is transmitted to the front left wheel axle 36L and the front right wheel axle 36R through the front wheel differential gear 35, whereby the front left wheel WFL and the front right wheel WFR are rotationally driven. Similarly, the driving force of the rear wheel rotary shaft 33 is transmitted to the rear left wheel axle 38L and the rear right wheel axle 38R through the rear wheel differential gear 37, whereby the rear left wheel WRL and the rear right wheel WRR are rotationally driven.

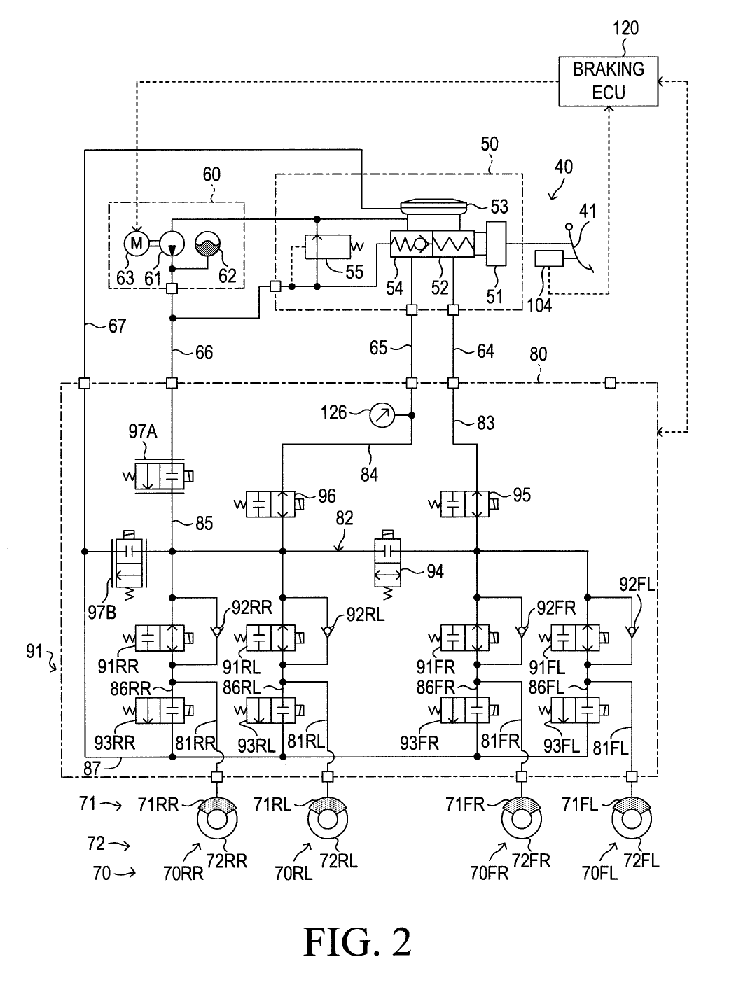

As shown in FIG. 2, the braking device 40 includes a brake pedal 41, a master cylinder unit 50, a power hydraulic pressure generator 60, a braking unit 70, hydraulic pressure control valve device 80, and the like.

The master cylinder unit 50 includes a hydraulic pressure booster 51, a master cylinder 52, a reservoir 53, a regulator 54, and a relief valve 55. The master cylinder unit 50 is a well-known master cylinder unit described, for example, in Japanese Patent Application Laid-open (Kokai) No. 2013-49292 and No. 2013-256253.

The power hydraulic pressure generator 60 is a power source for a hydraulic pressure, which includes a pump 61, an accumulator 62 and a motor 63. The power hydraulic pressure generator 60 is a well-known power hydraulic pressure generator described, for example, in Japanese Patent Application Laid-open (Kokai) No. 2013-49292 and No. 2013-256253.

The braking unit 70 is provided for each of the wheels, and includes a wheel cylinder 71 and a brake disk 72. Note that, for the elements provided for each of the wheel, a suffix FL for representing the front left wheel, a suffix FR for representing the front right wheel, a suffix RL for representing the rear left wheel, and a suffix RR for representing the rear right wheel are attached to the end of the reference numeral. However, when a wheel position does not need to be specified for the elements provided for each of the wheels, those suffixes are omitted. The braking unit 70 is also referred to as “hydraulic friction braking device.”

The wheel cylinders 71FL, 71FR, 71RL, and 71RR press brake pads to brake disks 72FL, 72FR, 72RL, and 72 RR, respectively, using the hydraulic pressure of hydraulic fluid which is supplied from the hydraulic pressure control valve device 80. The brake disks 72FL, 72FR, 72RL, and 72RR rotate with the wheels WFL, WFR, WRL, and WRR, respectively. In this manner, the wheel cylinder 71 applies a braking force to the wheel W.

The hydraulic control valve device 80 includes four separate passages 81FL, 81FR, 81RL, and 81RR respectively connected to the wheel cylinders 71FL, 71FR, 71RL, and 71RR, a main passage 82 which communicates among the separate passages 81FL, 81FR, 81RL, and 81RR, a master passage 83 which connects the main passage 82 and a master pipe 64, a regulator passage 84 which connects the main passage 82 and a regulator pipe 65, an accumulator passage 85 which connects the main passage 82 and an accumulator pipe 66. The master passage 83, the regulator passage 84 and the accumulator passage 85 are respectively connected in parallel to the main passage 82.

ABS holding valves 91 (91FL, 91FR, 91RL, and 91RR) are interposed in the separate passages 81FL, 81FR, 81RL, and 81RR, respectively. The ABS holding valve 91 is a normally open two-position solenoid valve which alternatively selects either a communication position or a shut-off position. Thus, the ABS holding valves 91FL, 91FR, 91RL, and 91RR respectively communicate the separate passages 81FL, 81FR, 81RL, and 81RR when the communication position is selected, and respectively shut off the separate passages 81FL, 81FR, 81RL, and 81RR when the shut-off position is selected.

Return check valves 92FL, 92FR, 92RL, and 92RR are respectively provided in parallel to the ABS holding valves 91FL, 91FR, 91RL, and 91RR in the separate passages 81FL, 81FR, 81RL, and 81RR. The return check valve 92 is the valve which shuts off a flow of the hydraulic fluid from the main passage 82 to the wheel cylinder 71 and allows a flow of the hydraulic fluid from the wheel cylinder 71 to the main passage 82.

Separate passages for pressure reduction 86FL, 86FR, 86RL, and 86RR are respectively connected to the separate passages 81FL, 81FR, 81RL, and 81RR. The separate passages for pressure reduction 86 are connected to a reservoir passage 87. The reservoir passage 87 is connected to the reservoir 53 via a reservoir pipe 67. ABS reducing valves 93FL, 93FR, 93RL, and 93RR are interposed in the separate passages for pressure reduction 86FL, 86FR, 86RL, and 86RR, respectively. The ABS reducing valve 93 is a normally closed two-position solenoid valve which alternatively selects either the communication position or the shut-off position. Thus, the ABS reducing valves 93FL, 93FR, 93RL, and 93RR respectively communicate the separate passages for pressure reduction 86FL, 86FR, 86RL, and 86RR when the communication position is selected, and respectively shut off the separate passages for pressure reduction 86FL, 86FR, 86RL, and 86RR when the shut-off position is selected.

When the wheels locks to slip, the ABS holding valve 91 and the ABS reducing valve 93 is controlled when an anti-skid braking which prevents the wheel from locking by reducing the wheel cylinder pressure and a distribution ratio adjustment braking are executed.

A communication valve 94 is provided in the middle of the main passage 82. A master cut valve 95 is provided in the middle of the master passage 83. A regulator cut valve 96 is provided in the middle of the regulator passage 84. A pressure boosting linear control valve 97A is provided in the middle of the accumulator passage 85. Further, the main passage 82 which is connected to the accumulator passage 85 is connected to the reservoir passage 87 via the pressure reducing linear control valve 97B. Such a configuration is well known and described in Japanese Patent Application Laid-open (Kokai) No. 2013-49292 and No. 2013-256253 for example. These are incorporated herein by reference.

The master cylinder pressure sensor 126 is provided on the upstream side from the regulator cut valve 96 in the regulator passage 84. The master cylinder pressure sensor 126 detects the hydraulic pressure of the hydraulic fluid on the upstream side from the regulator cut valve 96, that is, the hydraulic pressure of the hydraulic fluid supplied from the master cylinder unit 50 to the hydraulic pressure control valve device 80 as a master cylinder pressure Pm. The master cylinder pressure Pm has a value that reflects a depression amount of the brake pedal 41 requested by a driver of the vehicle, and is also referred to as “braking request value Pm.”

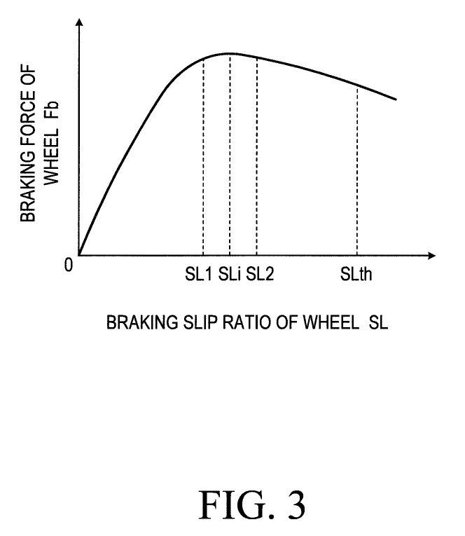

Incidentally, as shown in FIG. 3, the braking force of a wheel increases as a braking slip ratio SL becomes higher when the braking slip ratio SL is lower than a predetermined braking slip ratio (hereinafter also referred to as “ideal slip ratio”) SLi determined mainly by characteristics of a tire, and decreases as the braking slip ratio SL becomes higher when the braking slip ratio SL is higher than the ideal slip ratio SLi. The braking ECU 120 calculates the braking slip ratio SL of each wheel based on wheel speeds Vwfl, Vwfr, Vwrl, and Vwrr of the respective wheels, and executes anti-skid braking (hereinafter also referred to as “ABS control”) known in this technical field on each wheel.

The ABS control is performed by the braking device 40 adjusting hydraulic fluid pressure on each wheel so that, for example, the braking slip ratio SL of each wheel becomes closer to the ideal slip ratio SLi. More specifically, the braking ECU 120 first calculates the braking slip ratio SL of each wheel.

The braking slip ratio SL is defined as a ratio of a deviation between a vehicle body speed Vb and a wheel speed Vw to the vehicle body speed Vb. Normally, the vehicle body speed Vb cannot be detected, and hence an estimated vehicle body speed Vx, which is estimated based on the wheel speed Vw of each wheel, is used for the calculation of the braking slip ratio SL in place of the vehicle body speed Vb. Therefore, the braking slip ratio SL is calculated based on the following expression.

SL=(Vx−Vw)Nx (1)

The estimated vehicle body speed Vx is obtained by, for example, selecting the highest wheel speed Vwi among wheel speeds Vwi (Vwfl, Vwfr, Vwrl, and Vwrr) of the four wheels every predetermined sampling time period.

When there is a specific wheel having the calculated braking slip ratio SL exceeding a slip ratio threshold SLth higher than the ideal slip ratio SLi, the braking ECU 120 decreases the braking force of the specific wheel by decreasing hydraulic pressure applied to the brake unit 70 for the specific wheel. At this time, the braking ECU 120 decreases the slip ratio SL of the specific wheel so as to fall within a range between SL1 and SL2, which is a minute range including the ideal slip ratio SLi. A period during which the hydraulic fluid pressure is adjusted in this manner corresponds to an execution period of the ABS control. In the following description, the braking slip ratio SL is also referred to simply as “slip ratio SL,” a braking slip ratio SLf of the front wheel is also referred to simply as “front wheel slip ratio SLf,” and a braking slip ratio SLr of the rear wheel is also referred to simply as “rear wheel slip ratio SLr.”

Referring back to FIG. 1, the engine ECU 100 is connected to the 4WD ECU 110 described later and the braking ECU 120 described later so as to be capable of exchanging information via CAN (Controller Area Network) communication to and from those ECUs. The engine ECU 100 is electrically connected to an accelerator opening sensor 121, or the like. The engine ECU 100 is configured to receive output signals from those sensors. The accelerator opening sensor 121 is configured to generate output signal indicative of an operating amount AP of an accelerator pedal 121a which is provided so as to be operable by a driver. The engine ECU 100 is configured to make the driving unit 20 generate the driving force based on the signals from the accelerator opening sensor 121 or the like.

The 4WD ECU 110 is electrically connected to wheel speed sensors 122 (122FL, 122FR, 122RL, and 122RR), or the like. The 4WD ECU 110 is configured to receive output signals from those sensors. The wheel speed sensors 122FL, 122FR, 122RL, and 122RR are configured to generate output signals indicative of a wheel speed Vwfl of the front left wheel WFL, a wheel speed Vwfr of the front right wheel WFR, a wheel speed Vwrl of the rear left wheel WRL, and a wheel speed Vwrr of the rear right wheel WRR, respectively.

The 4WD ECU 110 controls the coupling torque Tcu of the differential restriction device 34. The differential restriction device 34 allows a full (complete) relative rotation between the front wheel rotary shaft 32 and the rear wheel rotary shaft 33 when the coupling torque Tcu is set to be zero, and does not allow any relative rotation (i.e., it prohibits a relative rotation) between the front rotary shaft 32 and the rear rotary shaft 33 when the coupling torque Tcu is set to a maximum value Tcumax. Further, when the coupling torque Tcu is set to be a value between 0 and the maximum value Tcumax, the differential restriction device 34 gradually raises the differential restriction degree between the front rotary shaft 32 and the rear rotary shaft 33 as the coupling torque Tcu becomes larger.

Therefore, the coupling torque Tcu is an index value indicating a differential restriction degree set by the differential restriction device 34. Setting the differential restriction degree means setting a value of the coupling torque Tcu.

The braking ECU 120 is electrically connected to a steering angle sensor 123, a yaw rate sensor 124, an acceleration sensor 125, a master cylinder pressure sensor 126, or the like. The braking ECU 120 is configured to receive output signals from those sensors. The steering angle sensor 123 is configured to generate output signal indicative of a steering angle St of the steering wheel 123a which is provided so as to be operable by the driver. The yaw rate sensor 124 is configured to generate output signal indicative of a yaw rate Yr of the vehicle 10. The acceleration sensor 125 is configured to generate output signal indicative of an acceleration/deceleration Gx of the vehicle 10. The master cylinder pressure sensor 126 is configured to generate output signal indicative of the master cylinder pressure Pm. It should be noted that the steering angle St detected by the steering angle sensor 123 and the yaw rate Yr detected by the yaw rate sensor 124 are positive, when vehicle 10 is turning leftward.

The braking ECU 120 calculates a target braking force Fbflt of the front left wheel WFL, a target braking force Fbfrt of the front right wheel WFR, a target braking force Fbrlt of the rear left wheel WRL, and a target braking force Fbrrt of the rear right wheel WRR, based on the master cylinder pressure Pm. The braking ECU 120 adjusts the braking pressures of the wheel cylinders 71FL, 71FR, 71RL, and 71RR by controlling the pressure boosting linear control valve 97A and the pressure reducing linear control valve 97B in such a manner that each of the braking forces becomes equal to each of the corresponding target braking forces.

### Operation

### Distribution between Braking Force of Front Wheels and Braking Force of Rear Wheels

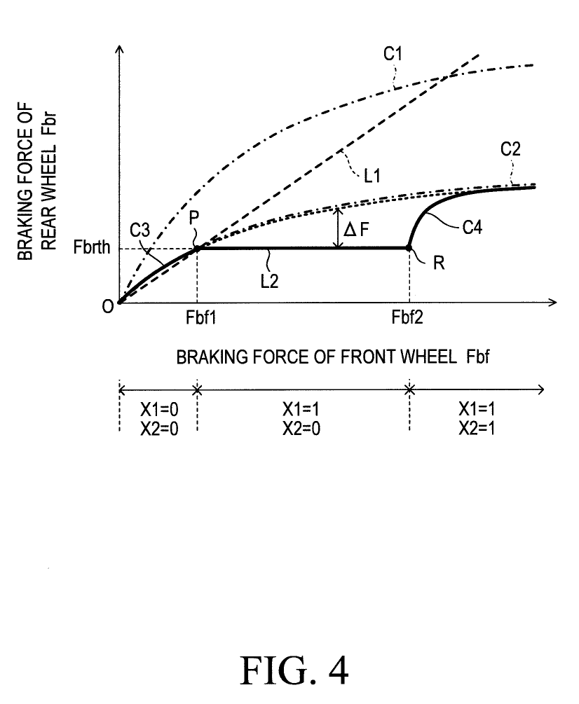

Hereinafter, an operation of the first control device will be described below with reference to FIG. 4. In FIG. 4, a curve Cl indicates a relationship between a braking force Fbf of the front wheels and a braking force Fbr of the rear wheels in a case where the braking force Fbf and the braking force Fbr change in accordance with an ideal distribution ratio at a time of maximum loading. A curve C2 indicates a relationship between the braking force Fbf of the front wheels and the braking force Fbr of the rear wheels in a case where the braking force Fbf and the braking force Fbr change in accordance with an ideal distribution ratio at a time of minimum loading. A straight line L1 and a straight line L2 indicate relationships between the braking force of the front wheels and the braking force of the rear wheels in a case where the coupling torque Tcu of the center differential device 31 is set to “0” at the time of minimum loading. In the following description, the setting of the coupling torque Tcu to “0” is also expressed as setting of the differential restriction degree between the front wheel rotary shaft 32 and the rear wheel rotary shaft 33 to a first degree. In addition, a traveling mode of the vehicle 10 in a case of the coupling torque Tcu being set to “0” is also referred to as “two-wheel drive mode.” The maximum loading refers to a state under which luggage of a maximum loading weight is loaded on the vehicle 10, while the minimum loading refers to a state under which no luggage is loaded on the vehicle 10 (with only the driver on board).

As can be understood from the straight line L1, in the two-wheel drive mode, when a total sum (hereinafter referred to as “vehicle request braking force”) of the braking force Fbf of the front wheels and the braking force Fbr of the rear wheels is small, the braking force Fbf of the front wheels and the braking force Fbr of the rear wheels are adjusted so as to change while maintaining a proportional relationship. The braking force of the rear wheels is adjusted so as to become smaller than the braking force of the rear wheels determined based on the ideal distribution ratio at the time of maximum loading. This front-rear braking force distribution ratio indicated by the straight line L1 is set by, for example, adjusting sizes of pistons of the wheel cylinders 71FL, 71FR, 71RL, and 71RR. Therefore, the front-rear braking force distribution ratio that has been set once cannot be changed with ease.

Meanwhile, the curve C2 indicating the ideal distribution ratio at the time of minimum loading has a slope decreasing as the vehicle request braking force increases. Therefore, when the vehicle request braking force increases, the curve C2 and the straight line L1 intersect at a point P in FIG. 4. More specifically, as the braking request value increases when a brake operation is performed in the two-wheel drive mode, the braking force Fbf of the front wheels and the braking force Fbr of the rear wheels increase along the straight line L1 from an origin O in FIG. 4. In this example, until the braking force Fbf of the front wheels and the braking force Fbr of the rear wheels reach values corresponding to the point P, the braking force Fbr of the rear wheels is smaller than a “braking force of the rear wheels determined by the braking force Fbf of the front wheels and the ideal distribution ratio at the time of minimum loading.” That is, the rear wheel slip ratio SLr is lower than the front wheel slip ratio SLf (SLr<SLf). When the braking force Fbf of the front wheels and the braking force Fbr of the rear wheels reach the values corresponding to the point P, the front wheel slip ratio SLf and the rear wheel slip ratio SLr become equal to each other. However, when the braking force Fbf of the front wheels and the braking force Fbr of the rear wheels further increase along the straight line L1 to exceed the values corresponding to the point P, the rear wheel slip ratio SLr becomes higher than the front wheel slip ratio SLf (SLr>SLf). The braking force of the rear wheels corresponding to the point P is referred to as “rear wheel braking force threshold Fbrth”.

When the rear wheel slip ratio SLr becomes higher than the front wheel slip ratio SLf, a lateral force that can be generated by the rear wheels becomes insufficient, and hence stable travelling performance of the vehicle deteriorates. Therefore, when the rear wheel slip ratio SLr becomes higher than the front wheel slip ratio SLf, the first control device determines that an execution condition for the distribution ratio adjustment braking has been satisfied, and executes the distribution ratio adjustment braking as described below. In the following description, the distribution ratio adjustment braking is also referred to as “EBD control.” That is, when the braking force Fbr of the rear wheels exceeds the rear wheel braking force threshold Fbrth, the first control device changes all the ABS holding valves 91RL and 91RR for the rear wheels to the shut-off position. The ABS pressure reducing valves 93RL and 93RR for the rear wheels are maintained at the shut-off position until the ABS control is started. As a result, the hydraulic pressure within the wheel cylinders 71RL and 71RR for the rear wheels is maintained, and hence, as indicated by the straight line L2, even when the braking force Fbf of the front wheels further increases, the braking force Fbr of the rear wheels is maintained at the rear wheel braking force threshold Fbrth, and a difference ΔF shown in FIG. 4 is thus increased. Therefore, the lateral force of the rear wheels is secured, and hence the stable travelling performance can be secured.

In other words, the EBD control is executed as follows. That is, when the coupling torque Tcu is set to “0”, the CPU of the braking ECU 120 (hereinafter also referred to simply as “CPU”) determines whether there has occurred a state (hereinafter also referred to as “first specific state”) that enables the braking force Fbr of rear left and right wheels to be estimated to have exceeded the rear wheel braking force threshold Fbrth. When determining that the first specific state has occurred, the CPU increases the braking force Fbf of the front left and right wheels by increasing the hydraulic pressure applied to the brake units 70FL and 70FR for the front left and right wheels as the braking request value (master cylinder pressure Pm) requested by the driver of the vehicle increases. Simultaneously, the CPU maintains the braking force Fbr of the rear left and right wheels at a constant value by maintaining the hydraulic pressure applied to the brake units 70RL and 70RR for the rear left and right wheels at the shut-off position for both the ABS holding valves 91RL and 91RR for the rear wheels.

Meanwhile, when the coupling torque Tcu is set to the maximum value Tcumax, the front wheels and the rear wheels are in a restrained state, and are therefore rotated at substantially the same speed to exhibit the rear wheel slip ratio SLr and the front wheel slip ratio SLf that are equal to each other. In the following description, the setting of the coupling torque Tcu to the maximum value Tcumax is also expressed as setting of the differential restriction degree between the front wheel rotary shaft 32 and the rear wheel rotary shaft 33 to a second degree. In addition, a traveling mode of the vehicle 10 when the coupling torque Tcu is set to the maximum value Tcumax is also referred to as “four-wheel drive mode.”

When the traveling mode of the vehicle 10 is set to the four-wheel drive mode, the braking force Fbf of the front wheels and the braking force Fbr of the rear wheels increase along the curve C2. Therefore, in the four-wheel drive mode, even when the braking force Fbf of the front wheels increases to exceed the value corresponding to the point P, the rear wheel slip ratio SLr does not become higher than the front wheel slip ratio SLf, and hence the EBD control execution condition described above is not satisfied. As a result, the EBD control is not executed, which causes the lateral force that can be generated by the rear wheels to become insufficient, and hence it becomes difficult to secure the stable travelling performance.

Therefore, the first control device determines whether a state (hereinafter also referred to as “second specific state”) under which the EBD control is determined to be executed occurs when a braking request is issued (braking operation is performed) by the driver in a case where the differential restriction degree is set to the second degree (that is, in a case where the vehicle 10 is traveling in the four-wheel drive mode). That is, the second specific state is a driving state under which, assuming that the differential restriction degree is set to the first degree (that is, assuming that the vehicle 10 is traveling in the two-wheel drive mode), it is highly probable that the rear wheel slip ratio SLr becomes higher than the front wheel slip ratio SLf.

The second specific state adopted by the first control device is a state under which a vehicle body speed Vbrk at a start of braking is higher than a predetermined vehicle body speed threshold value Vth. The reason is as follows. That is, as the vehicle body speed Vbrk at the start of braking becomes higher, a larger braking force is required for reducing the vehicle body speed, and hence when the vehicle body speed Vbrk at the start of braking is higher than the vehicle body speed threshold value Vth, the braking force having the value corresponding to the point P is generated. As a result, assuming that the vehicle 10 is traveling in the two-wheel drive mode, it is highly probable that the rear wheel slip ratio SLr becomes higher than the front wheel slip ratio SLf.

When determining that the second specific state has occurred, the first control device changes the coupling torque Tcu of the center differential device 31 from the maximum value Tcumax to “0”, to thereby switch the traveling mode of the vehicle 10 from the four-wheel drive mode to the two-wheel drive mode. In other words, the first control device changes the differential restriction degree from the second degree to the first degree.

Therefore, the braking force Fbf of the front wheels and the braking force Fbr of the rear wheels are increased not along the curve C2 but along the straight line L1 from the start of braking, and hence when the rear wheel braking force threshold Fbrth is exceeded, the first control device executes the above-mentioned EBD control (that is, maintains the braking force of the rear wheels).

In this manner, when the vehicle body speed Vbrk exceeds the predetermined vehicle body speed threshold value Vth in a case where the braking is started while the vehicle is traveling in the four-wheel drive mode, the first control device causes the vehicle to travel in the two-wheel drive mode. With this configuration, the first control device achieves a state under which the EBD control execution condition that the braking force Fbr of the rear wheels is larger than the rear wheel braking force threshold Fbrth can be satisfied. When the EBD control execution condition is actually satisfied, the first control device executes the EBD control. As a result, the first control device can secure the travelling stability of the vehicle 10.

Next, a case in which the ABS control is executed during the execution of the EBD control will be described. For example, it is assumed that, in FIG. 4, when the braking forces (front wheel braking force Fbf2 and rear wheel braking force Fbrth) at a point R have occurred, the front wheel slip ratio SLf increases to exceed the slip ratio threshold SLth, and the ABS control has been executed. The ABS control is normally performed individually on all the four wheels including not only the front wheels but also the rear wheels, and hence when the ABS control is executed, the execution of the EBD control targeted at the rear wheels is also suspended. Also in the first embodiment, when the ABS control is executed, the execution of the EBD control is suspended in the same manner.

When the ABS control is executed, the differential restriction degree that has been set to the first degree is set to a third degree, which is larger than the first degree and equal to or smaller than the second degree. That is, the third degree is set as a range in which the coupling torque Tcu is larger than “0” and equal to or smaller than the maximum value Tcumax. The third degree is further preferred to be set so as to increase the value of the coupling torque Tcu by a relatively small “predetermined value B” each time a predetermined time period elapses while there is a request for an increase in braking force. A final target value of the third degree is set to the maximum value Tcumax in the same manner as in the case of the second degree. Therefore, as the braking force increases, the braking force Fbf of the front wheels and the braking force Fbr of the rear wheels gradually increase as indicated by a curve C4, and become asymptotic to the curve C2 indicating a front-rear vertical load distribution ratio at the time of minimum loading.

The first control device thus sets the third degree so as to gradually increase (by the predetermined value B each time) for the following reason. That is, assuming that the first degree is switched directly to the third degree with the third degree being set to the maximum value Tcumax of the coupling torque Tcu, the braking force of the rear wheels sharply increases, and as a result, the lateral force of the rear wheels sharply decreases, which raises a fear that the travelling stability may deteriorate. In this manner, according to the first control device, it is possible to solve a problem that the braking force Fbr of the rear wheels becomes excessive when the ABS control is executed on the four-wheel drive vehicle having a relatively small loading amount during the execution of the EBD control.

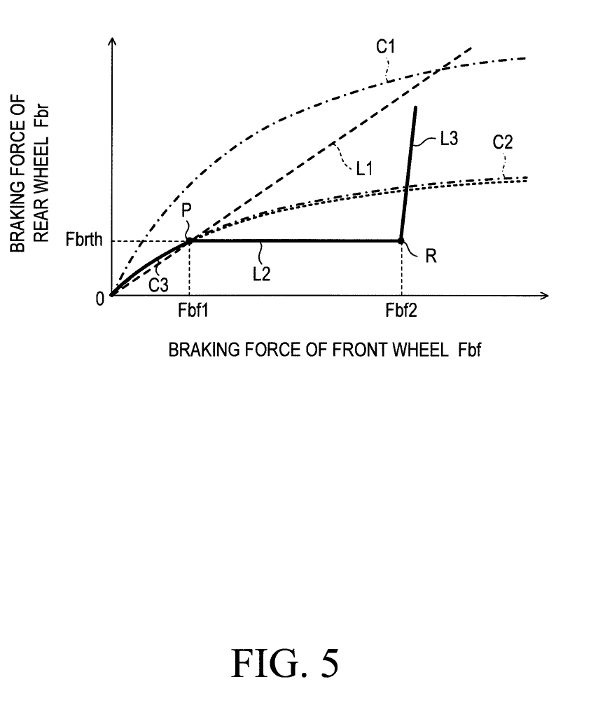

For comparison to the operation of the first control device, a detailed description is given of a problem of a method of continuously maintaining the differential restriction degree at the setting of the first degree even when the ABS control is executed at the point R in FIG. 5.

According to this method, the braking force transitions as follows. When the front wheel slip ratio SLf exceeds the slip ratio threshold SLth and the ABS control is executed on the front wheels at the point R in FIG. 5, the execution of the EBD control that has been executed on the rear wheels is suspended. The coupling torque Tcu is set to “0” at this time, and hence the braking force Fbr of the rear wheels starts to rise toward the straight line L1 indicating the front-rear braking force distribution ratio in the two-wheel drive mode. Even when the braking force Fbr of the rear wheels increases to exceed the curve C2 indicating the front-rear vertical load distribution ratio at the time of minimum loading, that is, even when the rear wheel slip ratio SLr becomes higher than the front wheel slip ratio SLf, the ABS control is being preferentially executed, which inhibits the EBD control from being executed. As a result, the braking force Fbr of the rear wheels further rises.

However, the front-rear braking force distribution ratio is a distribution ratio suitable for the vehicle 10 in a maximum loaded state, and hence the distributed braking force of the rear wheels is excessive for the vehicle 10 in a minimum loaded state. Therefore, before the braking force Fbr of the rear wheels reaches the front-rear braking force distribution ratio, the rear wheel slip ratio SLr exceeds the slip ratio threshold SLth, and the ABS control is executed on the rear wheels. When the ABS control is executed on the rear wheels, the braking force Fbr of the rear wheels is reduced.

When the ABS control is executed on the rear wheels to set the rear wheel slip ratio SLr within an appropriate range, the ABS control being executed on the rear wheels is stopped. After that, the braking force Fbr of the rear wheels again starts to rise toward the front-rear braking force distribution ratio, but the rear wheel slip ratio SLr exceeds the slip ratio threshold SLth, and hence the ABS control is again executed on the rear wheels.

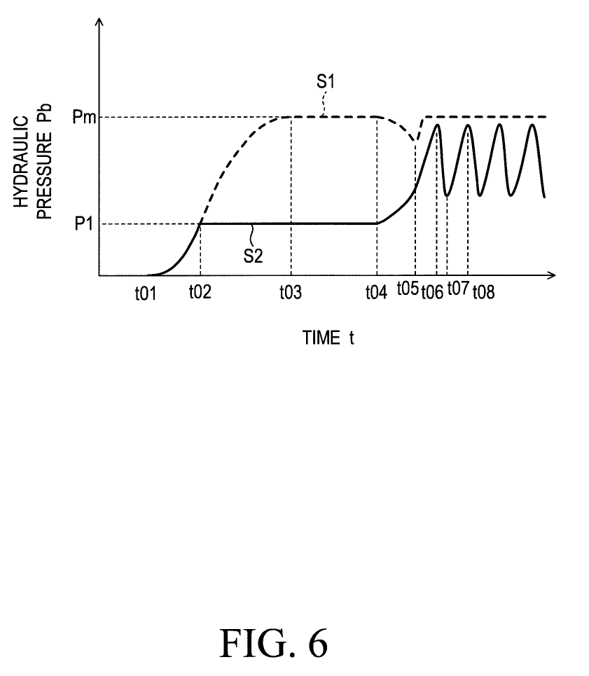

In this manner, in the case where the braking force keeps increasing while the differential restriction degree is continuously maintained at the setting of the first degree, execution and stopping of the ABS control are repeatedly performed on the rear wheels. A state under which the execution and stopping of the ABS control are repeatedly performed will be described below with reference to a timing chart shown in FIG. 6.

In FIG. 6, a broken line S1 indicates a temporal change in hydraulic fluid pressure on the front wheels (hydraulic pressure within the wheel cylinders 71FL and 71FR), and a solid line S2 indicates a temporal change in hydraulic fluid pressure on the rear wheels (hydraulic pressure within the wheel cylinders 71RL and 71RR). Assuming that the braking is started at a time t01, the hydraulic fluid pressure on the front wheels starts to rise from the time t01. Meanwhile, the hydraulic fluid pressure on the rear wheels starts to rise from the time t01 in the same manner as in the case of the hydraulic fluid pressure on the front wheels, but is subjected to the execution of the EBD control at a time t02 to stop increasing at a value P1. At a time t03, the value of the hydraulic fluid pressure on the front wheels reaches a value equal to that of the master cylinder pressure Pm.

Assuming that the front wheel slip ratio SLf exceeds the slip ratio threshold SLth at a time t04 and the ABS control is executed on the front wheels, the hydraulic fluid pressure on the front wheels decreases. After that, assuming that the front wheel slip ratio SLf enters a predetermined slip ratio range (range from SL1 to SL2) at a time t05, the execution of the ABS control is stopped, and the hydraulic fluid pressure on the front wheels starts to rise.

Meanwhile, when the EBD control being executed on the rear wheels is suspended at the time t04 due to the execution of the ABS control, the hydraulic fluid pressure on the rear wheels starts to rise toward the master cylinder pressure Pm. In other words, the hydraulic fluid pressure on the rear wheels starts to rise so as to be controlled in accordance with the front-rear braking force distribution ratio indicated by the straight line L1 in FIG. 5. Assuming that the rear wheel slip ratio SLr exceeds the slip ratio threshold SLth at a time t06, the ABS control is executed on the rear wheels, and the hydraulic fluid pressure on the rear wheels is decreased. When the hydraulic fluid pressure on the rear wheels is decreased, the rear wheel slip ratio SLr becomes an appropriate slip ratio, and the execution of the ABS control is stopped. Assuming that the execution of the ABS control is stopped at a time t07, the hydraulic fluid pressure on the rear wheels again starts to rise from the time t07 toward the master cylinder pressure Pm. After that, when the rear wheel slip ratio SLr exceeds the predetermined value at a time t08 and the ABS control is executed on the rear wheels, the hydraulic fluid pressure on the rear wheels is decreased. In this manner, when the first degree is maintained as the differential restriction degree even after the ABS control is executed during the EBD control, the execution and stopping of the ABS control are repeated for the rear wheels.

Therefore, a time average of the hydraulic fluid pressure on the rear wheels during a period in which the execution and stopping of the ABS control are repeated for the rear wheels has an intermediate value between the master cylinder pressure Pm and hydraulic fluid pressure P1 at a time of an EBD operation. Therefore, a time average Fbravg of the braking force Fbr of the rear wheels is larger than the braking force exerted in accordance with vertical load distribution at the time of minimum loading.

In this manner, when the first degree is maintained as the differential restriction degree even after the ABS control is executed during the EBD control, the travelling stability of the vehicle 10 can be secured by the EBD control until the ABS control is executed. However, once the ABS control is executed, the braking force of the rear wheels becomes excessive, which raises a fear that it may become difficult to secure the travelling stability of the vehicle.

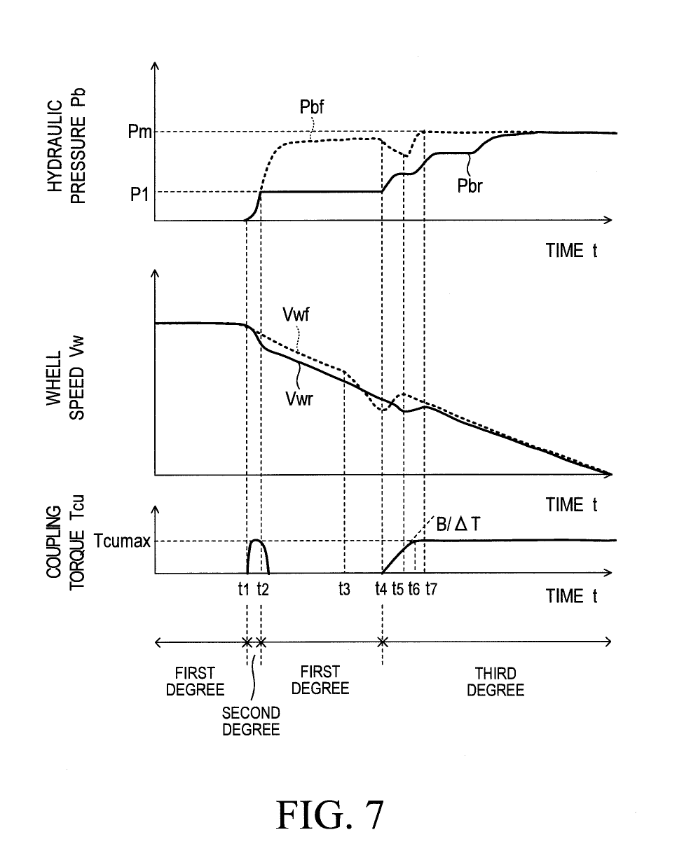

Meanwhile, the operation of the first control device is described below in detail with reference to a timing chart shown in FIG. 7.

In FIG. 7, temporal changes in hydraulic fluid pressure Pbf on the front wheels, a hydraulic fluid pressure Pbr on the rear wheels, wheel speed Vwf of the front wheels, wheel speed Vwr of the rear wheels, and coupling torque Tcu are shown. It is assumed that a brake operation is performed by the driver of the vehicle 10 immediately before a time t1. When detecting the brake operation performed by the driver, the first control device sets the differential restriction degree that has been set to the first degree (Tcu=0) at the time t1 to the second degree (Tcu=Tcumax). The coupling torque Tcu starts to increase from the time t1. The hydraulic fluid pressure Pbf on the front wheels and the hydraulic fluid pressure Pbr on the rear wheels start to rise from the time t1. The wheel speed Vwf of the front wheels and the wheel speed Vwr of the rear wheels start to decrease from the time t1.

At a time t2, the differential restriction degree is set to the first degree (Tcu=0). After that, the EBD control execution condition is satisfied, and the EBD control is executed. That is, the ABS holding valves 91RL and 91RR each select the shut-off position to maintain the hydraulic fluid pressure Pbr on the rear wheels. The rear wheel slip ratio SLr is higher than the front wheel slip ratio SLf immediately before the EBD control execution condition is satisfied, that is, immediately before the time t2, and hence at the time t2, the wheel speed Vwr of the rear wheels is lower than the wheel speed Vwf of the front wheels. After the time t2, the wheel speed Vwf of the front wheels and the wheel speed Vwr of the rear wheels decrease at substantially the same slope until a time t3.

It is assumed that at the time t3, a decrease rate of the wheel speed Vwf of the front wheels is increased. This assumption presupposes that, for example, a road surface of a road on which the vehicle 10 is traveling has become slippery to increase the front wheel slip ratio SLf.

It is assumed that at a time t4, the front wheel slip ratio SLf exceeds the slip ratio threshold SLth, and the anti-skid control (ABS control) is executed. When the ABS control is executed, in order to decrease the front wheel slip ratio SLf, the hydraulic fluid pressure Pbf on the front wheels is decreased, and the EBD control is stopped. When the EBD control is stopped, the braking force Fbr of the rear wheels starts to rise toward the front-rear vertical load distribution ratio. Therefore, the hydraulic fluid pressure Pbr on the rear wheels starts to increase in accordance with an increase in braking force Fbr of the rear wheels. The hydraulic fluid pressure Pbr on the rear wheels is gradually raised while the ABS holding valves 91RL and 91RR are each switched between the communication position and the shut-off position every predetermined time period so as to inhibit the braking force Fbr of the rear wheels from becoming excessive.

At the time t4, the differential restriction degree is changed to the third degree. More specifically, the first control device increases the coupling torque Tcu by the relatively small value B each time a given time period AT elapses. That is, the first control device raises the coupling torque Tcu from the first degree (Tcu=0) to the third degree (maximum value Tcumax) with a slope of B/LT.

At a time t5, the wheel speed Vwr of the rear wheels turns to rise. This is because the differential restriction degree (coupling torque Tcu) is set larger, and hence the wheel speed Vwr of the rear wheels becomes closer to the wheel speed Vwf of the front wheels. The reason why the hydraulic fluid pressure Pbf on the front wheels turns to rise in a vicinity of the time t5 is that the front wheel slip ratio SLf has become an appropriate value to stop the ABS control being executed on the front wheels.

At a time t6, the third degree reaches the maximum value Tcumax. After that, the third degree is maintained at the maximum value Tcumax.

The wheel speed Vwr of the rear wheels, which has become closer to the wheel speed Vwf of the front wheels because of the differential restriction degree that has been set larger, substantially agrees with the wheel speed Vwf of the front wheels at a time t7, and then transitions in the same manner as the wheel speed Vwf of the front wheels.

### Specific Operation of First Control Device

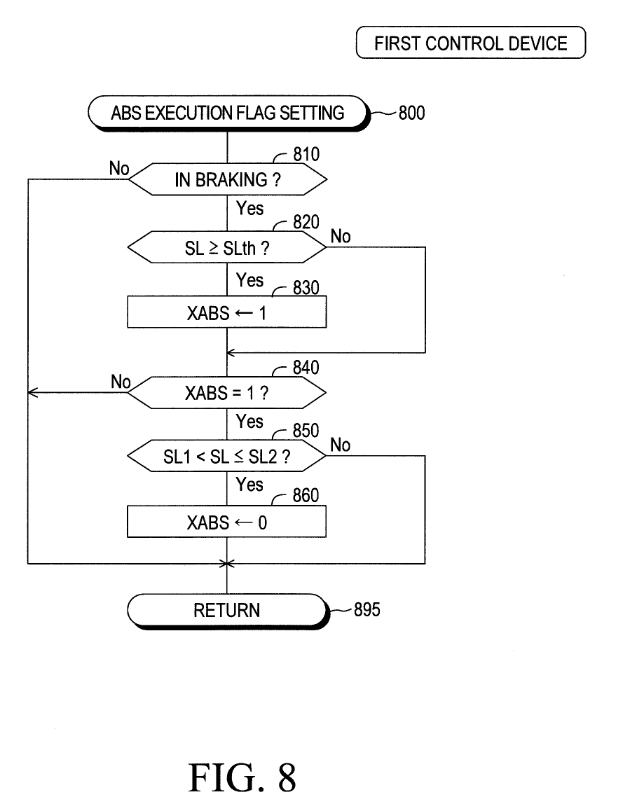

Hereinafter, actual operations of the first control device will be described with reference to FIG. 8 to FIG. 10.

### ABS Execution Flag Setting

The CPU of the braking ECU 120 is configured to execute an ABS execution flag setting routine illustrated by a flowchart in FIG. 8 every time a constant time elapses.

The CPU starts the process from Step 800 at a predetermined time point to proceed to Step 810 at which the CPU determines whether the vehicle 10 is braking. More specifically, it is determined whether the vehicle 10 is braking based on, for example, whether the master cylinder pressure Pm is equal to or higher than a predetermined value Pmth1.

When the master cylinder pressure Pm is equal to or higher than the predetermined value Pmth1, that is, when the vehicle 10 is braking, the CPU makes a “Yes” determination at Step 810 to proceed to Step 820 at which the CPU determines whether at least one of the wheels (WFL, WFR, WRL, and WRR) has a slip ratio SL equal to or higher than the slip ratio threshold SLth.

When the slip ratio SL of at least one of the four wheels is equal to or higher than the slip ratio threshold SLth, the CPU makes a “Yes” determination at Step 820 to proceed to Step 830 at which the CPU sets a value of an ABS execution flag XABS to “1” to proceed to Step 840. Meanwhile, when the slip ratio SL of every one of the wheels is lower than the slip ratio threshold SLth, the CPU makes a “No” determination at Step 820 to directly proceed to Step 840.

At Step 840, the CPU determines whether the value of the ABS execution flag XABS is “1”. When the value of the ABS execution flag XABS is “0”, the CPU makes a “No” determination at Step 840, and proceeds directly to Step 895 to tentatively terminate the present routine. Meanwhile, when the value of the ABS execution flag XABS is “1”, the CPU makes a “Yes” determination at Step 840 to proceed to Step 850 at which the CPU determines whether the slip ratio SL is higher than the first slip ratio SL1 and equal to or lower than the second slip ratio SL2 for the wheel being subjected to the execution of the ABS control.

When the slip ratio SL is higher than the first slip ratio SL1 and equal to or lower than the second slip ratio SL2, the CPU makes a “Yes” determination at Step 850 to proceed to Step 860 at which the CPU sets the value of the ABS execution flag XABS to “0”, and proceeds to Step 895 to tentatively terminate the present routine. Meanwhile, when the slip ratio SL is equal to or lower than the first slip ratio SL1 or higher than the second slip ratio SL2, the CPU makes a “No” determination at Step 850, and proceeds directly to Step 895 to tentatively terminate the present routine.

When the vehicle 10 is not braking, the CPU makes a “No” at Step 810, and proceeds directly to Step 895 to tentatively terminate the present routine.

### EBD Execution Flag Setting

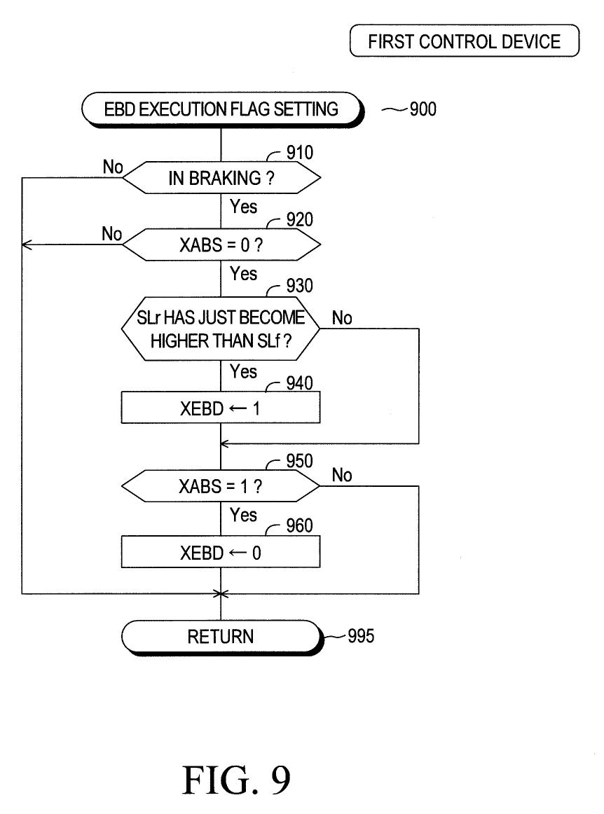

The CPU of the braking ECU 120 is configured to execute an EBD execution flag setting routine illustrated by a flowchart in FIG. 9 every time a constant time elapses.

The CPU starts the process from Step 900 at a predetermined time point to proceed to Step 910 at which the CPU determines whether the vehicle 10 is braking. More specifically, the CPU determines whether the master cylinder pressure Pm is equal to or higher than the predetermined value Pmth1. When the master cylinder pressure Pm is equal to or higher than the predetermined value Pmth1, that is, when the vehicle 10 is braking, the CPU makes a “Yes” determination at Step 910 to proceed to Step 920 at which the CPU determines whether the value of the ABS execution flag XABS is “0”.

When the value of the ABS execution flag XABS is “1”, the CPU makes a “No” determination at Step 920, and proceeds directly to Step 995 to tentatively terminate the present routine. Meanwhile, when the value of the ABS execution flag XABS is “0”, the CPU makes a “Yes” determination at Step 920 to proceed to Step 930 at which the CPU determines whether the rear wheel slip ratio SLr has just become higher than the front wheel slip ratio SLf. In other words, the CPU determines in Step 930 whether the first specific state that enables the braking force Fbr of the rear wheels to be estimated to have exceeded the rear wheel braking force threshold (Fbrth) has occurred. The rear wheel slip ratio SLr is a value calculated as an average value between the slip ratio SLrl of the left rear wheel and the slip ratio SLrr of the right rear wheel, and the front wheel slip ratio SLf is a value calculated as an average value between the left front wheel slip ratio SLfl and the right front wheel slip ratio SLfr. That is, the EBD control execution condition is that the average value between the slip ratio SLrl of the left rear wheel and the slip ratio SLrr of the right rear wheel has just become higher than the average value between the left front wheel slip ratio SLfl and the right front wheel slip ratio SLfr.

When the braking force Fbr of the rear wheels has just become larger than the rear wheel braking force threshold Fbrth, the CPU makes a “Yes” determination at Step 930 to proceed to Step 940 at which the CPU sets a value of an EBD execution flag XEBD to “1” to proceed to Step 950. Meanwhile, when the braking force Fbr of the rear wheels has not just become larger than the rear wheel braking force threshold Fbrth, the CPU makes a “No” determination at Step 930 to directly proceed to Step 950.

Subsequently, at Step 950, the CPU determines whether the value of the ABS execution flag XABS is “1”. When the value of the ABS execution flag XABS is “1”, the CPU makes a “Yes” determination at Step 950 to proceed to Step 960 at which the CPU sets the value of the EBD execution flag XEBD to “0”, and proceed to Step 995 to tentatively terminate the present routine. Meanwhile, when the value of the ABS execution flag XABS is “0”, the CPU makes a “No” determination at Step 950, and proceeds directly to Step 995 to tentatively terminate the present routine.

When the vehicle 10 is not braking, the CPU makes a “No” determination at Step 910, and proceeds directly to Step 995 to tentatively terminate the present routine.

### Coupling Torque Control

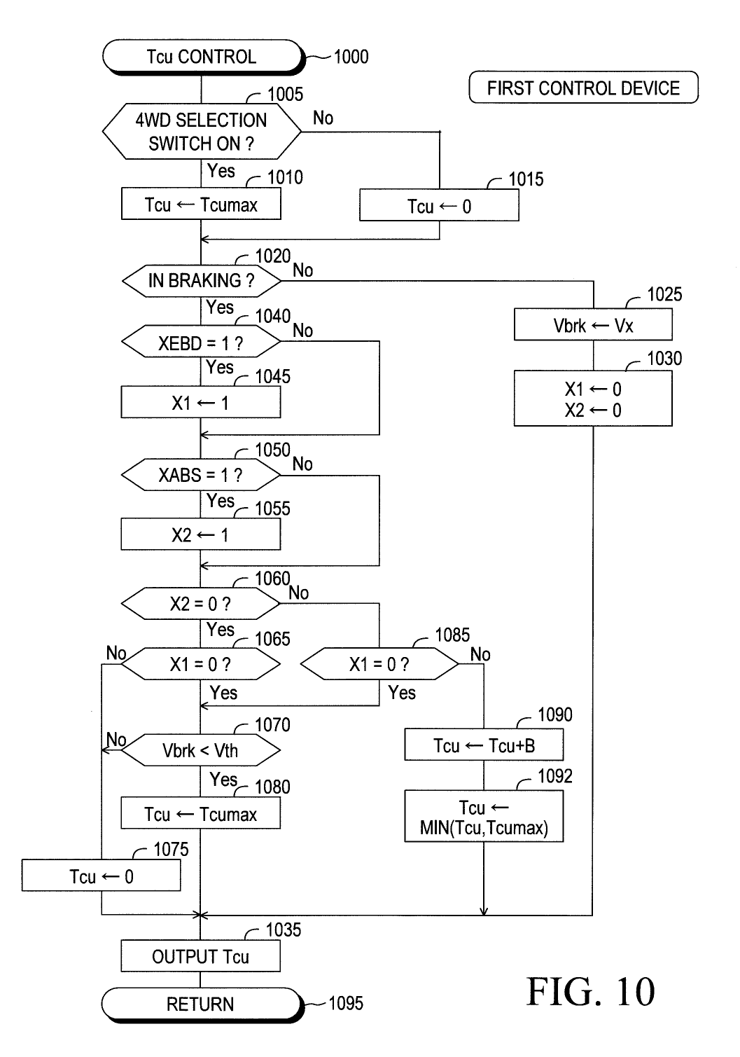

The CPU of the 4WD ECU 110 is configured to execute a coupling torque control routine illustrated by a flowchart in FIG. 10 every time a constant time elapses. When an ignition key switch is turned on, the coupling torque Tcu is set to “0” in a separately-executed initialization routine.

The CPU starts the process from Step 1000 at a predetermined time point to proceed to Step 1005 at which the CPU determines whether a 4WD selection switch (not shown) is set to “ON” by the driver of the vehicle. When the 4WD selection switch is set to “ON”, the CPU makes a “Yes” determination at Step 1005 to proceed to Step 1010 at which the CPU sets the coupling torque Tcu to the maximum value Tcumax to proceed to Step 1020. Meanwhile, when the 4WD selection switch is set to “OFF”, the CPU makes a “No” determination at Step 1005 to proceed to Step 1015 at which the CPU sets the coupling torque Tcu to “0” to proceed to Step 1020.

Subsequently, in Step 1020, the CPU determines whether the vehicle 10 is braking. More specifically, it is determined whether the master cylinder pressure Pm is equal to or higher than the predetermined value Pmth1. When the master cylinder pressure Pm is lower than the predetermined value Pmth1, that is, when the vehicle 10 is not braking, the CPU makes a “No” determination at Step 1020 to proceed to Step 1025 at which the CPU acquires the estimated vehicle body speed Vx at that time point as the vehicle body speed Vbrk at the start of braking and store the estimated vehicle body speed Vx in the RAM. Subsequently, the CPU proceeds to Step 1030 to set each of values of an EBD execution history flag X1 and an ABS execution history flag X2 to “0”.

The EBD execution history flag X1 is a flag to be set to “1” when the EBD control is executed at least once during a period in which the braking operation is performed by the driver, that is, during a period after the driver steps on a brake pedal until the brake pedal is released (hereinafter also referred to as “during a series of braking steps”). The ABS execution history flag X2 is a flag to be set to “1” when the ABS control is executed at least once during the series of braking steps.

Subsequently, the CPU proceeds to Step 1035 to set the coupling torque Tcu to “0” so that an actual coupling torque agrees with the set coupling torque Tcu, and proceeds to Step 1095 to tentatively terminate the present routine.

Meanwhile, when the vehicle 10 is braking, the CPU makes a “Yes” determination at Step 1020 to proceed to Step 1040 at which the CPU determines whether the value of the EBD execution flag XEBD is “1”. When the value of the EBD execution flag XEBD is “1”, the CPU makes a “Yes” determination at Step 1040 to proceed to Step 1045 at which the CPU sets the value of the EBD execution history flag X1 to “1” to proceed to Step 1050. Meanwhile, when the value of the EBD execution flag XEBD is “0”, the CPU makes a “No” determination at Step 1040 to directly proceed to Step 1050.

Subsequently, at Step 1050, the CPU determines whether the value of the ABS execution flag XABS is “1”. When the value of the ABS execution flag XABS is “1”, the CPU makes a “Yes” determination at Step 1050 to proceed to Step 1055 at which the CPU sets the value of the ABS execution history flag X2 to “1” to proceed to Step 1060. Meanwhile, when the value of the ABS execution flag XABS is “0”, the CPU makes a “No” determination at Step 1050 to directly proceed to Step 1060.

The following descriptions will be given by combining the values of the EBD execution history flag X1 and the ABS execution history flag X2 when braking is performed into the following four cases.
(1) Case in which the value of the EBD execution history flag X1 is “0” and the value of the ABS execution history flag X2 is “0”
(2) Case in which the value of the EBD execution history flag X1 is “1” and the value of the ABS execution history flag X2 is “0”
(3) Case in which the value of the EBD execution history flag X1 is “1” and the value of the ABS execution history flag X2 is “1”
(4) Case in which the value of the EBD execution history flag X1 is “0” and the value of the ABS execution history flag X2 is “1”

(1) Case in which the value of the EBD execution history flag X1 is “0” and the value of the ABS execution history flag X2 is “0”

Subsequently, at Step 1060, the CPU determines whether the value of the ABS execution history flag X2 is “0”. On the above-mentioned assumption, the value of the ABS execution history flag X2 is “0”. Therefore, the CPU makes a “Yes” determination at Step 1060 to proceed to Step 1065 at which the CPU determines whether the value of the EBD execution history flag X1 is “0”. On the above-mentioned assumption, the value of the EBD execution history flag X1 is “0”. Therefore, the CPU makes a “Yes” determination at Step 1065 to proceed to Step 1070 at which the CPU determines whether the vehicle body speed Vbrk at the start of braking is lower than the predetermined vehicle body speed threshold value Vth.

When the vehicle body speed Vbrk at the start of braking is equal to or higher than the predetermined vehicle body speed threshold value Vth, the CPU makes a “No” determination at Step 1070 to proceed to Step 1075 at which the CPU sets the coupling torque Tcu to “0”. Subsequently, the CPU proceeds to Step 1035 to control the differential restriction device 34 so that the actual coupling torque agrees with the set coupling torque Tcu, and advances to Step 1095 to tentatively terminate the present routine. Meanwhile, when the vehicle body speed Vbrk at the start of braking is lower than the predetermined vehicle body speed threshold value Vth, the CPU makes a “Yes” determination at Step 1070 to proceed to Step 1080 at which the CPU sets the coupling torque Tcu to the maximum value Tcumax. Subsequently, the CPU proceeds to Step 1035 to control the differential restriction device 34 so that the actual coupling torque agrees with the set coupling torque Tcu, and proceeds to Step 1095 to tentatively terminate the present routine.

In this manner, after starting braking control, the CPU sets the value of the coupling torque Tcu to the maximum value Tcumax (sets the four-wheel drive mode) when the vehicle body speed Vbrk at the start of braking is lower than the predetermined vehicle body speed threshold value Vth. Meanwhile, when the vehicle body speed Vbrk at the start of braking is equal to or higher than the predetermined vehicle body speed threshold value Vth, the CPU sets the coupling torque Tcu to “0” to release restriction on the differential operation (sets the two-wheel drive mode). A state under which the vehicle body speed Vbrk at the start of braking is equal to or higher than the predetermined vehicle body speed threshold value Vth represents a state under which the rear wheel slip ratio SLr is highly probable to exceed the front wheel slip ratio SLf, that is, a state under which an EBD operation condition is highly probable to be satisfied. Therefore, when the braking control is continuously performed to satisfy the EBD operating condition, the EBD control is started.

(2) Case in which the value of the EBD execution history flag X1 is “1” and the value of the ABS execution history flag X2 is “0”

The CPU makes a “Yes” determination at Step 1060 to proceed to Step 1065, a “No” determination at Step 1065, and proceeds to Step 1075 to set the coupling torque Tcu to “0”. Subsequently, the CPU proceeds to Step 1035 to control the differential restriction device 34 so that the actual coupling torque agrees with the set coupling torque Tcu, and proceeds to Step 1095 to tentatively terminate the present routine. Therefore, on this assumed condition, the coupling torque Tcu is maintained at “0” to execute the EBD control.

(3) Case in which the value of the EBD execution history flag X1 is “1” and the value of the ABS execution history flag X2 is “1”

The CPU makes a “No” determination at Step 1060 to proceed to Step 1085 at which the CPU determines whether the value of the EBD execution history flag X1 is “0”. On the above-mentioned assumption, the value of the EBD execution history flag X1 is “1”. Therefore, the CPU makes a “No” determination at Step 1085 to proceed to Step 1090 at which the CPU sets the coupling torque Tcu as a value obtained by adding the relatively small predetermined value B to the previous value of the coupling torque Tcu.

Subsequently, the CPU proceeds to Step 1092 to compare the value of the coupling torque Tcu set in Step 1090 to the maximum value Tcumax, and sets the smaller value as the coupling torque Tcu. In other words, the CPU sets the coupling torque Tcu so as not to exceed the maximum value Tcumax. Subsequently, the CPU proceeds to Step 1035 to control the differential restriction device 34 so that the actual coupling torque agrees with the set coupling torque Tcu, and proceeds to Step 1095 to tentatively terminate the present routine.

Incidentally, when the ABS execution flag XABS is set to “1” in the separately-executed ABS execution flag setting routine (Step 830), the EBD execution flag XEBD is set to “0” in the separately-executed EBD execution flag setting routine (Step 960). However, even when the EBD execution flag XEBD is set to “0” while the ABS control is being executed during the execution of the EBD control, the differential restriction degree is changed to the third degree as in the case (3) described above, to thereby be able to prevent the braking force Fbr of the rear wheels from becoming excessive.

(4) Case in which the value of the EBD execution history flag X1 is “0” and the value of the ABS execution history flag X2 is “1”

The CPU makes a “No” determination at Step 1060 to proceed to Step 1085, and makes a “Yes” determination at Step 1085 to proceed to Step 1070.

When the vehicle body speed Vbrk at the start of braking is equal to or higher than the predetermined vehicle body speed threshold value Vth, the CPU makes a “No” determination at Step 1070, and proceeds to Step 1075 to set the coupling torque Tcu to “0”. Subsequently, the CPU proceeds to Step 1035 to control the differential restriction device 34 so that the actual coupling torque agrees with the set coupling torque Tcu, and proceeds to Step 1095 to tentatively terminate the present routine. Meanwhile, when the vehicle body speed Vbrk at the start of braking is lower than the predetermined vehicle body speed threshold value Vth, the CPU makes a “Yes” determination at Step 1070 to proceed to Step 1080 at which the CPU sets the coupling torque Tcu to the maximum value Tcumax. Subsequently, the CPU proceeds to Step 1035 to control the differential restriction device 34 so that the actual coupling torque agrees with the set coupling torque Tcu, and proceeds to Step 1095 to tentatively terminate the present routine.

In this manner, even when the ABS control is executed, the CPU executes the same processing as in the case (1) described above as long as the EBD control has not yet been executed.

As described above, the first control device includes a differential restriction control unit (4WD ECU 110) configured to cause the differential restriction device 34 to change the differential restriction degree. The first control device further includes a braking control unit (braking ECU 120) configured to: determine, when the differential restriction degree is set to the first degree, whether the first specific state that enables the braking force Fbr of the rear left and right wheels to be estimated to have exceeded the rear wheel braking force threshold Fbrth has occurred; cause, when determining that the first specific state has occurred, the braking device 40 to perform the distribution ratio adjustment braking (EBD control) for increasing the braking force Fbf of the front left and right wheels by increasing the hydraulic pressure applied to the brake units 70FL and 70FR for the front left and right wheels as the braking request value increases, and maintaining the braking force of the rear left and right wheels at a constant value by maintaining the hydraulic pressure applied to the brake units 70RL and 70RR for the rear left and right wheels; calculate, when the differential restriction degree is set to the first degree, the slip ratio SL of each of the left front wheel WFL, the right front wheel WFR, the left rear wheel WRL, and the right rear wheel WRR; and cause the braking device 40 to perform the anti-skid braking (ABS control) for decreasing the braking force of the specific wheel having the calculated slip ratio exceeding the slip ratio threshold SLth by decreasing the hydraulic pressure applied to the brake unit 70 for the specific wheel, to thereby decrease the slip ratio of the specific wheel.

The brake control unit 120 is configured to cause the braking device 40 to suspend the EBD control when the ABS control is started while the EBD control is being performed. The differential restriction control unit 110 is configured to change the differential restriction degree to the third degree, which is larger than the first degree and equal to or smaller than the second degree, when the ABS control is started while the EBD control is being performed.

In this manner, even when the ABS control is executed on the four-wheel drive vehicle, for which the front-rear braking force distribution ratio in the two-wheel drive mode is set with front-rear vertical load distribution at the time of maximum loading being used as a reference, while the EBD control is being executed with the loading amount of the vehicle being small, the first control device can prevent the lateral force of the rear wheels from decreasing to secure the travelling stability of the vehicle.

The above-mentioned first specific state (EBD control execution condition) is not limited to the state immediately after the average value between the slip ratio SLrl of the left rear wheel and the slip ratio SLrr of the right rear wheel has become higher than the average value between the left front wheel slip ratio SLfl and the right front wheel slip ratio SLfr. For example, the first specific state may be a state immediately after the higher slip ratio between the slip ratio SLrl of the left rear wheel and the slip ratio SLrr of the right rear wheel has become higher than the lower slip ratio between the left front wheel slip ratio SLfl and the right front wheel slip ratio SLfr.

The above-mentioned first specific state may be a state immediately after the wheel speed Vwr of the rear wheels has become higher than the wheel speed Vwf of the front wheels. That is, the CPU of the braking ECU 120 may be configured to determine whether the wheel speed Vwr of the rear wheels has just become lower than the wheel speed Vwf of the front wheels in Step 930A (not shown) replacing Step 930 of FIG. 9. More specifically, the first specific state may be a state immediately after the average value of the wheel speed Vwrl of the left rear wheel and the wheel speed Vwrr of the right rear wheel has become higher than the average value of the wheel speed Vwfl of the left front wheel and the wheel speed Vwfr of the right front wheel. In addition, the first specific state may be a state immediately after the lower wheel speed between the wheel speed Vwrl of the left rear wheel and the wheel speed Vwrr of the right rear wheel has become higher than the higher wheel speed of the wheel speed Vwfl of the left front wheel and the wheel speed Vwfr of the right front wheel.

The above-mentioned first specific state may be a state under which the braking force Fbr of the rear wheels estimated from the master cylinder pressure Pm has exceeded the rear wheel braking force threshold Fbrth obtained by referring to a look-up table for defining a relationship between a predetermined loading weight and a rear wheel braking force threshold Fbrth. That is, the CPU of the braking ECU 120 may be configured to determine in Step 930B (not shown) replacing Step 930 of FIG. 9 whether the estimated braking force Fbr of the rear wheels has just become larger than the rear wheel braking force threshold Fbrth that takes the loading weight of the vehicle into consideration.

The above-mentioned second specific state is not limited to a state under which the vehicle body speed Vbrk at the start of braking has exceeded the predetermined vehicle body speed threshold value Vth, and may be, for example, a state under which the braking request value (for example, master cylinder pressure Pm) requested by the driver of the vehicle has exceeded a predetermined braking request threshold value (master cylinder pressure threshold value Pmth). That is, the CPU of the 4WD ECU 110 may be configured to determine in Step 1070A (not shown) replacing Step 1070 of FIG. 10 whether the master cylinder pressure Pm is larger than the master cylinder pressure threshold value Pmth. In this case, the first control device stores a predetermined value of the master cylinder pressure Pm for generating the braking force at the point P in FIG. 4 as the master cylinder pressure threshold value Pmth. The first control unit releases the restriction on the differential operation when the master cylinder pressure Pm becomes equal to or higher than the master cylinder pressure threshold value Pmth. That is, the first control unit releases the restriction on the differential operation at the point P at which the master cylinder pressure Pm agrees with the master cylinder pressure threshold value Pmth. With this configuration, the braking force increases from the point P along a braking force distribution ratio (straight line L1) in the two-wheel drive mode, and hence when the braking force reaches a value corresponding to the point P, the EBD control execution condition ((rear wheel slip ratio SLr)>(front wheel slip ratio SLf)) for normal EBD control is satisfied.

When the EBD control is executed at the point P, the pressure within the wheel cylinders 71RL and 71RR for the rear wheels is maintained. As a result, as indicated by the straight line L2 in FIG. 4, the braking force Fbr of the rear wheels is maintained at the constant value Fbrth even when the braking force Fbf of the front wheels increases.

In addition, the above-mentioned specific state may be a state under which a magnitude (absolute value) of the acceleration/deceleration Gx of the vehicle is larger than a magnitude (absolute value) of a deceleration threshold value -gth. When the acceleration/deceleration Gx is a negative value and the absolute value is large, a large braking force is considered to have occurred. Therefore, when the acceleration/deceleration Gx becomes equal to or smaller than a predetermined deceleration threshold value −gth1 (where gth1 is a positive value), the first control device sets the coupling torque Tcu to “0”. The value of the deceleration threshold value −gth1 is defined as, for example, a deceleration that is liable to cause the braking force at the point P in FIG. 4. In the following description, the acceleration/deceleration Gx is also referred to as “deceleration Gx.” That is, the CPU of the 4WD ECU 110 may be configured to determine in Step 1070B (not shown) replacing Step 1070 of FIG. 10 whether the magnitude (absolute value) of the deceleration Gx of the vehicle is larger than the magnitude (absolute value) of the deceleration threshold value −gth1 (whether the deceleration Gx is smaller than the deceleration threshold value −gth1).

### Second Embodiment

Next, a description is given of a control device according to a second embodiment of the present invention (hereinafter also referred to as “second control device”). The second control device is different from the first control device in that the second control device sets the differential restriction degree to the first degree instead of the second degree in a range in which the braking force is relatively small, for example, a range in which the braking force Fbr of the rear wheels is smaller than the rear wheel braking force threshold Fbrth. The following description is directed to the second control device.

As described above, in the range in which the braking force Fbr of the rear wheels is smaller than the rear wheel braking force threshold Fbrth (range from the origin O to the point P in FIG. 4), the braking force of the rear wheels based on the front-rear braking force distribution ratio (straight line L1) for the braking force Fbf of the specific front wheel is lower than the braking force of the rear wheels based on the front-rear vertical load distribution ratio (curve C2) at the time of minimum loading for the braking force Fbf of the same front wheels.

From the viewpoint of the travelling stability of the vehicle 10 at the time of braking, in a range in which the front-rear braking force distribution ratio L1 is lower than the front-rear vertical load distribution ratio C2 at the time of minimum loading (range in which the braking force Fbr of the rear wheels is smaller than the rear wheel braking force threshold Fbrth), the braking force is preferred to be distributed to the front wheels and the rear wheels in accordance with the front-rear braking force distribution ratio L1. Therefore, in consideration of the above-mentioned viewpoint, the second control device sets the differential restriction degree between the front wheel rotary shaft 32 and the rear wheel rotary shaft 33 small (for example, sets the coupling torque Tcu to “0”) in the range in which the front-rear braking force distribution ratio L1 is lower than the front-rear vertical load distribution ratio C2 at the time of minimum loading, to thereby distribute the braking force to the front wheels and the rear wheels in accordance with the front-rear braking force distribution ratio L1.

Incidentally, the second control device identifies the “range in which the front-rear braking force distribution ratio L1 is lower than the front-rear vertical load distribution ratio C2 at the time of minimum loading” in the following manner. An absolute value |Gx| of the deceleration Gx of the vehicle 10 is relatively small at an initial stage of the braking at which the driver starts the braking operation, that is, at a timing at which the braking force starts to occur. However, as the braking force increases after the driver steps on the brake pedal 41, the absolute value |Gx| of the deceleration Gx increases. As can be understood from FIG. 4, the absolute value |Gx| of the deceleration Gx tends to increase as a distance from the origin increases. Therefore, the second control device sets the differential restriction degree small in a range in which the absolute value |Gx| of the deceleration Gx is smaller than a predetermined value, for example, sets the coupling torque Tcu to 0. With this configuration, the second control device can identify the range in which the front-rear braking force distribution ratio L1 is lower than the front-rear vertical load distribution ratio C2 at the time of minimum loading.

### Specific Operation of Second Control Device

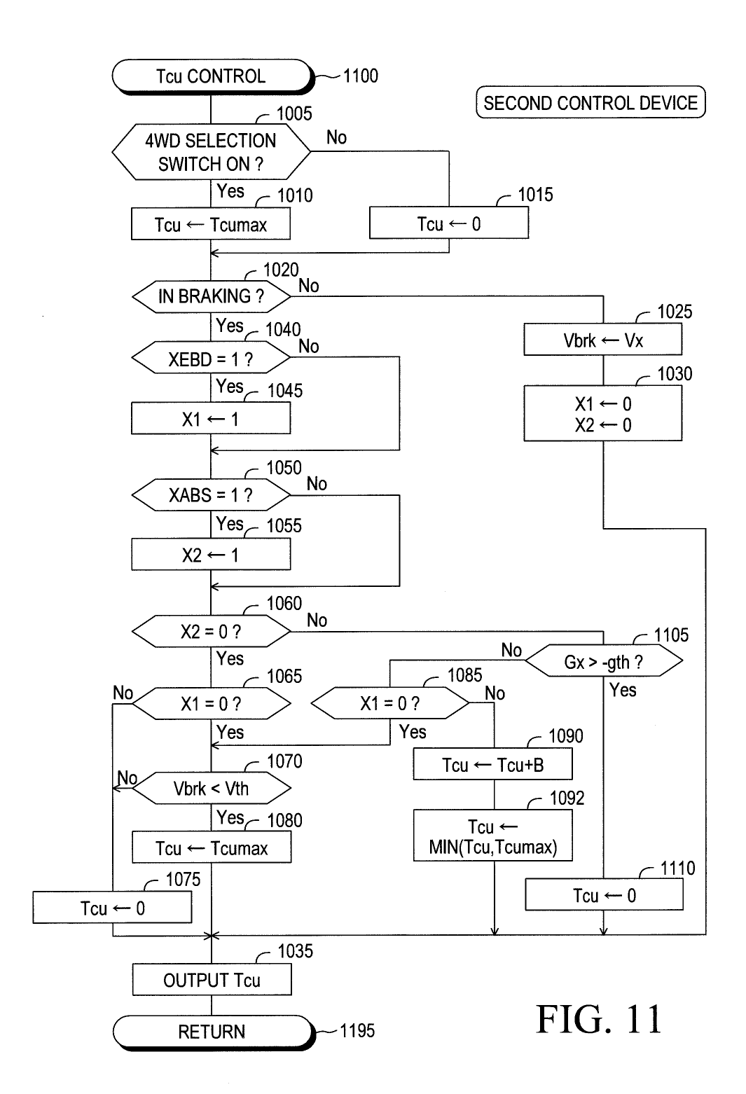

Hereinafter, actual operations of the second control device will be described with reference to FIG. 11. In FIG. 11, the same steps as those in FIG. 10 are denoted by the same reference symbols, and detailed descriptions of the operations of those steps are omitted below in some cases.

### Coupling Torque Control

The CPU of the 4WD ECU 110 is configured to execute a coupling torque control routine illustrated by a flowchart in FIG. 11 every time a constant time elapses. When the ignition key switch is turned on, the coupling torque Tcu is set to “0” in the separately-executed initialization routine.

When the CPU starts the process from Step 1100 at a predetermined time point to proceed to Step 1005 at which the CPU sets the coupling torque Tcu to the maximum value Tcumax or “0” depending on a selection state of the 4WD selection switch to proceed to Step 1020. When the vehicle 10 is not braking, the CPU makes a “No” determination at Step 1020 to proceed to Step 1025 at which the CPU acquires the estimated vehicle body speed Vx at that time point as the vehicle body speed Vbrk at the start of braking and store the estimated vehicle body speed Vx in the RAM. Subsequently, the CPU proceeds to Step 1030 to set each of the values of the EBD execution history flag X1 and the value of the ABS execution history flag X2 to “0”. Subsequently, the CPU proceeds to Step 1035 to control the differential restriction device 34 so that the actual coupling torque agrees with the set coupling torque Tcu, and proceeds to Step 1195 to tentatively terminate the present routine.

Meanwhile, when the vehicle 10 is braking, the CPU makes a “Yes” determination at Step 1020 to proceed to Step 1040.

When the value of the EBD execution flag XEBD is “1”, the CPU makes a “Yes” determination at Step 1040 to proceed to Step 1045 at which the CPU sets the value of the EBD execution flag XEBD to “1” to proceed to Step 1050. Meanwhile, when the value of the EBD execution flag XEBD is “0”, the CPU makes a “No” determination at Step 1040 to directly proceed to Step 1050.

Subsequently, when the value of the ABS execution flag XABS is “1”, the CPU determines “Yes” in Step 1050, and advances to Step 1055 to set the value of the ABS execution history flag X2 to “1”, and advances to Step 1060. Meanwhile, when the value of the ABS execution flag XABS is “0”, the CPU determines “No” in Step 1050, and advances directly to Step 1060. The following descriptions will be given based on the different cases.

(1) Case in which the value of the EBD execution history flag X1 is “0” and the value of the ABS execution history flag X2 is “0”

Subsequently, the CPU makes a “Yes” determination at Step 1060 to proceed to Step 1065, and makes a “Yes” determination at Step 1065 to proceed to Step 1070. When the vehicle body speed Vbrk at the start of braking is equal to or higher than the predetermined vehicle body speed threshold value Vth, the CPU makes a “No” determination at Step 1070 to proceed to Step 1075 at which the CPU sets the coupling torque Tcu to “0”. Subsequently, the CPU proceeds to Step 1035 to control the differential restriction device 34 so that the actual coupling torque agrees with the set coupling torque Tcu, and proceeds to Step 1195 to tentatively terminate the present routine.

Meanwhile, when the vehicle body speed Vbrk at the start of braking is lower than the predetermined vehicle body speed threshold value Vth, the CPU makes a “Yes” determination at Step 1070 to proceed to Step 1080 at which the CPU sets the coupling torque Tcu to the maximum value Tcumax. Subsequently, the CPU proceeds to Step 1035 to control the differential restriction device 34 so that the actual coupling torque agrees with the set coupling torque Tcu, and proceeds to Step 1195 to tentatively terminate the present routine.

(2) Case in which the value of the EBD execution history flag X1 is “1” and the value of the ABS execution history flag X2 is “0”

The CPU makes a “Yes” determination at Step 1060 to proceed to Step 1065. Subsequently, the CPU makes a “No” determination at Step 1065 to proceed to Step 1075 at which the CPU sets the coupling torque Tcu to “0”. Subsequently, the CPU proceeds to Step 1035 to control the differential restriction device 34 so that the actual coupling torque agrees with the set coupling torque Tcu, and proceeds to Step 1195 to tentatively terminate the present routine.

(3) Case in which the value of the EBD execution history flag X1 is “1” and the value of the ABS execution history flag X2 is “1”

The CPU makes a “No” determination at Step 1060 to proceed to Step 1105 at which the CPU determines whether the deceleration Gx is larger than the predetermined deceleration value −gth (where gth is a positive value).

When the deceleration Gx is larger than the predetermined deceleration threshold value −gth, that is, the absolute value |Gx| of the deceleration Gx is smaller than the absolute value gth of the predetermined deceleration threshold value −gth, the CPU makes a “Yes” determination at Step 1105 to proceed to Step 1110. Subsequently, the CPU sets the coupling torque Tcu to “0” at Step 1110, and proceeds to Step 1035 to control the differential restriction device 34 so that the actual coupling torque agrees with the set coupling torque Tcu, and proceeds to Step 1195 to tentatively terminate the present routine.

Meanwhile, when the deceleration Gx is equal to or smaller than the predetermined deceleration threshold value −gth, that is, when the absolute value |Gx| of the deceleration Gx is equal to or larger than the absolute value gth of the predetermined deceleration threshold value −gth, the CPU makes a “No” determination at Step 1105 to proceed to Step 1085. On the above-mentioned assumption, the CPU makes a “No” determination at Step 1085 to proceed to Step 1090 at which the CPU sets the coupling torque Tcu as a value obtained by adding the relatively small predetermined value B to the previous value of the coupling torque Tcu.

Subsequently, the CPU proceeds to Step 1092 to compare the value of the coupling torque Tcu set in Step 1090 to the maximum value Tcumax, and sets the smaller value as the coupling torque Tcu. Subsequently, the CPU proceeds to Step 1035 to control the differential restriction device 34 so that the actual coupling torque agrees with the set coupling torque Tcu, and proceeds to Step 1095 to tentatively terminate the present routine.

(4) Case in which the value of the EBD execution history flag X1 is “0” and the value of the ABS execution history flag X2 is “1”

The CPU makes a “No” determination at Step 1060 to proceed to Step 1105. When the deceleration Gx is larger than the predetermined deceleration threshold value −gth, the CPU makes a “Yes” determination at Step 1105 to proceed to Step 1110 at which the CPU sets the coupling torque Tcu to “0”. Subsequently, the CPU proceeds to Step 1035 to control the differential restriction device 34 so that the actual coupling torque agrees with the set coupling torque Tcu, and proceeds to Step 1195 to tentatively terminate the present routine.

Meanwhile, when the deceleration Gx is equal to or smaller than the predetermined deceleration threshold value −gth, the CPU makes a “No” determination at Step 1105 to proceed to Step 1085, and makes a “Yes” determination at Step 1085 to advance to Step 1070.

When the vehicle body speed Vbrk at the start of braking is equal to or higher than the predetermined vehicle body speed threshold value Vth, the CPU makes a “No” determination at Step 1070 to proceed to Step 1075 at which the CPU sets the coupling torque Tcu to “0”. Subsequently, the CPU proceeds to Step 1035 to control the differential restriction device 34 so that the actual coupling torque agrees with the set coupling torque Tcu, and proceeds to Step 1195 to tentatively terminate the present routine. Meanwhile, when the vehicle body speed Vbrk at the start of braking is lower than the predetermined vehicle body speed threshold value Vth, the CPU makes a “Yes” determination at Step 1070 to proceed to Step 1080 at which the CPU sets the coupling torque Tcu to the maximum value Tcumax. Subsequently, the CPU proceeds to Step 1035 to control the differential restriction device 34 so that the actual coupling torque agrees with the set coupling torque Tcu, and proceeds to Step 1195 to tentatively terminate the present routine.

In this manner, even when the ABS control is executed, the CPU executes the same processing as in the case (1) described above as long as the deceleration Gx is equal to or smaller than the predetermined deceleration threshold value −gth and the EBD control has not yet been executed.

In this manner, the second control device sets the coupling torque Tcu to “0” when the ABS control is being executed or has been executed (X2=1) in the range of the braking force in which the front-rear braking force distribution ratio L1 is lower than the front-rear vertical load distribution ratio C2 at the time of minimum loading. With this configuration, the braking force distribution ratio of the rear wheels to the front wheels can be decreased in a situation in which the ABS control is executed even when the braking force being generated is relatively small (for example, situation in which the braking is performed on a low-μ road). As a result, it is possible to improve the travelling stability of the vehicle 10.

### Modification Example

The present invention is not limited to the above-mentioned embodiments, and various modification examples can be employed within the scope of the present invention as described below.

In the descriptions of the specific operations of the first control device and the second control device, the vehicle body speed Vbrk at the start of braking is used as a value relating to whether the EBD control execution condition is satisfied (value relating to an occurrence of a specific state), but the master cylinder pressure Pm and the deceleration Gx of the vehicle 10, which are described above, may be used. Further, any combination of those three parameters may be freely selected as the value related to the occurrence of the specific state. That is, as values relating to the occurrence of a specific state, the vehicle body speed Vbrk at the start of braking and the master cylinder pressure Pm may be used, the vehicle body speed Vbrk at the start of braking and the deceleration Gx may be used, or the master cylinder pressure Pm and the deceleration Gx may be used. In addition, all the above-mentioned three parameters may be used.

In the above-mentioned embodiments, it is determined whether the vehicle 10 is braking based on whether the master cylinder pressure Pm is equal to or higher than the predetermined value Pmth1. However, it may be determined whether the vehicle 10 is braking based on whether a brake pedal depression amount BP is equal to or larger than a predetermined depression amount threshold value BPth.

The second control device identifies the “range in which the front-rear braking force distribution ratio L1 is smaller than the front-rear vertical load distribution ratio C2 at the time of minimum loading” based on the absolute value |Gx| of the deceleration Gx being smaller than a predetermined value, but may identify the above-mentioned range based on the braking force Fbr of the rear wheels being smaller than the rear wheel braking force threshold Fbrth. That is, the CPU of the 4WD ECU 110 may be configured to determine whether the braking force Fbr of the rear wheels is smaller than the rear wheel braking force threshold Fbrth in Step 1105A (not shown) replacing Step 1105 of FIG. 11.

In the above-mentioned embodiments, the ABS execution flag setting routine and the EBD execution flag setting routine are executed by the CPU of the braking ECU 120, but may be executed by the CPU of the 4WD ECU 110 instead of the CPU of the braking ECU 120. Further, the CPU of the 4WD ECU 110 and the CPU of the braking ECU 120 may cooperate with each other to execute the ABS execution flag setting routine and the EBD execution flag setting routine. In another case, those ECUs may be integrated into one ECU, and a CPU of the ECU obtained through the integration may execute those routines.

In the above-mentioned embodiments, the coupling torque control routine is executed by the CPU of the 4WD ECU 110, but may be executed by the CPU of the braking ECU 120 instead of the CPU of the 4WD ECU 110. Further, the CPU of the 4WD ECU 110 and the CPU of the braking ECU 120 may cooperate with each other to execute the coupling torque control routine. In another case, those ECUs may be integrated into one ECU, and a CPU of the ECU obtained through the integration may execute the coupling torque control routine.

What is claimed is:

1. A control device for a four-wheel drive vehicle, which is to be applied to a four-wheel drive vehicle,
the four-wheel drive vehicle including:
a driving unit configured to generate a driving force;
a center differential device configured to:
transmit the driving force to a front wheel rotary shaft and a rear wheel rotary shaft; and
allow a differential operation between the front wheel rotary shaft and the rear wheel rotary shaft;
a differential restriction device configured to enable a differential restriction degree between the front wheel rotary shaft and the rear wheel rotary shaft to be changed to have a value equal to or larger than a first degree, which fully allows the differential operation, and equal to or smaller than a second degree, which disallows the differential operation, and is larger than the first degree; and
a braking device configured to:
apply hydraulic pressure, which increases as a braking request value being a request value of a braking force to be applied to the four-wheel drive vehicle increases, to hydraulic friction braking devices provided for respective wheels, which include front left and right wheels and rear left and right wheels, through a hydraulic pressure passage shared by the respective wheels, to thereby change a braking force of the front left and right wheels and a braking force of the rear left and right wheels so that a distribution ratio between the braking force of the front left and right wheels and the braking force of the rear left and right wheels maintains a constant value; and
enable braking forces of the respective wheels to be set independently of one another by changing the hydraulic pressure applied to the hydraulic friction braking devices for the respective wheels independently wheel by wheel,
the control device comprising:
a differential restriction control unit configured to cause the differential restriction device to change the differential restriction degree; and
a braking control unit configured to:
determine, when the differential restriction degree is set to the first degree, whether a first specific state that enables the braking force of the rear left and right wheels to be estimated to have exceeded a rear wheel braking force threshold has occurred, and cause, when determining that the first specific state has occurred, the braking device to perform distribution ratio adjustment braking for increasing the braking force of the front left and right wheels by increasing the hydraulic pressure applied to the hydraulic friction braking devices for the front left and right wheels as the braking request value increases, and maintaining the braking force of the rear left and right wheels at a constant value by maintaining the hydraulic pressure applied to the hydraulic friction braking devices for the rear left and right wheels; and
calculate, when the differential restriction degree is set to the first degree, a slip ratio of each of the front left and right wheels and the rear left and right wheels, and cause the braking device to perform anti-skid braking for decreasing a braking force of a specific wheel having the calculated slip ratio exceeding a slip ratio threshold by decreasing the hydraulic pressure applied to one of the hydraulic friction braking devices for the specific wheel, to thereby decrease a slip ratio of the specific wheel,
wherein,
the braking control unit is configured to cause the braking device to suspend the distribution ratio adjustment braking when the anti-skid braking is started during a period in which the distribution ratio adjustment braking is being performed, and
the differential restriction control unit is configured to change the differential restriction degree to a third degree, which is larger than the first degree and equal to or smaller than the second degree, when the anti-skid braking is started during the period in which the distribution ratio adjustment braking is being performed.

2. A control device for a four-wheel drive vehicle according to claim 1, wherein the differential restriction control unit is configured to:
determine, when the differential restriction degree is set to the second degree, whether there has occurred a second specific state under which the first specific state is highly liable to occur assuming that the differential restriction degree is set to the first degree and the braking force of the front left and right wheels and the braking force of the rear left and right wheels are increased during a period in which a distribution ratio between the braking force of the front left and right wheels and the braking force of the rear left and right wheels is maintained at a constant level; and
change, when determining that the second specific state has occurred, the differential restriction degree from the second degree to the first degree.

3. A control device for a four-wheel drive vehicle according to claim 1, wherein the differential restriction control unit is configured to set the differential restriction degree to the first degree when the anti-skid braking is started before the braking force of the rear left and right wheels exceeds the rear wheel braking force threshold during a period in which the differential restriction degree is set to the second degree and the braking control unit is increasing the braking force of the front left and right wheels and the braking force of the rear left and right wheels.

4. A control device for a four-wheel drive vehicle according to claim 2, wherein the differential restriction control unit is configured to set the differential restriction degree to the first degree when the anti-skid braking is started before the braking force of the rear left and right wheels exceeds the rear wheel braking force threshold during a period in which the differential restriction degree is set to the second degree and the braking control unit is increasing the braking force of the front left and right wheels and the braking force of the rear left and right wheels.
